(19) United States
(12) Patent Application Publication
(10) Pub. No.: US 2026/0141410 A1
(43) Pub. Date: May 21, 2026

(54) METHOD, APPARATUS AND SYSTEM FOR PUBLISHING MARKET DATA UPDATES USING A REPROGRAMMABLE HARDWARE DEVICE AND SOFTWARE

(71) Applicant: BGC PARTNERS, L.P., NEW YORK, NY (US)

(72) Inventors: Jonathan Joshua, Scotch Plains, NJ (US); Bijoy Paul, New York, NY (US)

(21) Appl. No.: 19/451,188

(22) Filed: Jan. 16, 2026

Related U.S. Application Data
(63) Continuation of application No. PCT/US23/28091, filed on Jul. 19, 2023.

(51) Int. Cl. G06Q 30/0201

(52) U.S. Cl. CPC G06Q 30/0201

(57) ABSTRACT

Method, apparatus and system may control routing of market data update messages respectively of market data events, based on asset type, to programmable hardware device circuitry or processors for processing, and transmitting distribution messages containing filtered event data of the market data events to one or more client devices of subscribers permissioned to receive at least some portion of event data of the market data events as the filtered event data.

### CROSS REFERENCE TO RELATED APPLICATIONS

This application is a continuation of PCT Application No. PCT/US2023/28091 filed Jul. 19, 2023. The present disclosure is related to International application No. PCT/US2023/014105 filed Feb. 28, 2023, U.S. application Ser. No. 17/818,773 filed Aug. 10, 2022 and U.S. application Ser. No. 17/343,042 filed Jun. 9, 2021, the disclosures of which are incorporated by reference herein.

### TECHNICAL FIELD

The present disclosure generally relates to publishing events to computing devices based on filter information and, in particular, processing market data update messages to track market data events in order books for clients and transmitting messages containing filtered event data of a market data event indicated in a market data update message to client devices of respective clients.

### BACKGROUND

Computing devices of respective entities exchange data with other computing devices of other respective entities over communication networks for multitudes of applications. For example, computer implemented exchange systems (also referred to as simply exchange systems) enable trading of financial assets, such as financial instruments, and non-fungible tokens (NFTs) and cryptocurrencies, and have continued to evolve to accommodate the ever growing number of global exchanges and volume of daily trades.

An exchange system implements an order book for each financial asset which is tradeable by the exchange system. Each order book may be used to store a real time list of outstanding orders in memory for the associated asset and represents the interests of buyers and sellers. Order books may be visualized at a user interface provided by an exchange system, for example, to allow the user to better understand current market conditions. The user interface may also allow a user to execute one or more order actions, such as submitting new orders to buy or sell an asset, modifying previously submitted orders and cancelling orders. In some cases, an exchange system may provide an application programming interface (API) to enable a computer algorithm to access an order book and execute any aforementioned order action on behalf of a user including querying the order book and receiving real time order and/or trade updates.

Exchange systems are often required to process vast amounts of order actions by users or an API, and store trading data associated with execution of trades to satisfy an order. The processing may include receiving and executing hundreds to thousands of order actions and related trades per second, for example. Exchange systems may implement a process for managing order books for a given asset including submission of new orders (e.g., on the buy or sell side), updating existing orders within an order book and cancellation of orders and removal from an order book. Execution of trades in connection with an order book may include an algorithm or process for matching submitted orders to contra-side order(s) in the order book. After trade execution, an exchange system may store a representation of each executed trade as trading data within a database. In addition, the exchange system may output the trading data via market data updates which may be utilized by users via a network connection, for example.

For certain asset types, such as, for example, on-the-run U.S. treasuries, the amount of order actions, such as orders for the sale or purchase that are received or orders for sale and purchase for such assets that are matched, each second is so large that a burst of market data reflecting the order actions provided for market data publication to a computing device implementing market data update publication functions for respective clients, may overwhelm the data processing and storage capacity of the computing device. In such circumstances, the publication of market data updates to clients who subscribe to receive real time market data from the computing device is delayed, sometimes hundreds of microseconds, such that clients do not timely receive updated market data of interest subscribed to by the clients. The delay in publication of updated market data to the subscriber clients may disadvantage the subscribers relative to other parties, such as the parties who entered the orders or are parties to matched orders, who have access to the updated market data in real time.

Accordingly, there exists a need for method, apparatus and system for processing market data events that may avoid delays in publication of market data updates for high volume asset types to clients subscribed to receive event data of market data events associated with the asset types.

### SUMMARY

In accordance with an aspect of the present disclosure, an apparatus may include at least one programmable integrated circuit configured to be communicatively coupled to a plurality of computing devices as market data update sources; in which the at least one programmable integrated circuit includes: an interface circuit configured to receive, from each computing device, a market data update message; a selection circuit configured to selectively route a market data update message received at the interface circuit over a first path or a second path, based on an asset type indicated in the market data update message, in which the second path extends external to the at least one programmable integrated circuit; a feed generation circuit configured to generate, for a first market data update message received over the first path from the selection circuit, based on filter information, at least one first distribution message; and a distribution circuit configured to: receive, from the feed generation circuit, the at least one first distribution message for the first market data update message and, from external to the at least one programmable integrated circuit, at least one second distribution message for a second market data update message routed from the selection circuit over the second path; and cause the at least one programmable integrated circuit to output the at least one first distribution message and the at least one second distribution message respectively to at least one first client device of a plurality of client devices.

In accordance with an aspect of the present disclosure, a method may include controlling, by at least one programmable integrated circuit configured to be communicatively coupled to a plurality of computing devices as market data update sources, in which the at least one programmable integrated circuit includes an interface circuit, a selection circuit, a feed generation circuit and a distribution circuit, to: receive, at the interface circuit, from each computing device, a market data update message; selectively route, at the selection circuit, a market data update message received at the interface circuit over a first path or a second path, based on an asset type indicated in the market data update message, in which the second path extends external to the at least one programmable integrated circuit; generate, at the feed generation circuit, for a first market data update message received over the first path from the selection circuit, based on filter information, at least one first distribution message; and receive at the distribution circuit, from the feed generation circuit, the at least one first distribution message for the first market data update message and, from external to the at least one programmable integrated circuit, at least one second distribution message for a second market data update message routed from the selection circuit over the second path; and cause, at the distribution circuit, the at least one programmable integrated circuit to output the at least one first distribution message and the at least one second distribution message respectively to at least one first client device of a plurality of client devices.

In accordance with an aspect of the present disclosure, a non-transitory storage medium may be configured to store instructions which, when executed by at least one programmable integrated circuit configured to be communicatively coupled to a plurality of computing devices as market data update sources, in which the at least one programmable integrated circuit includes an interface circuit, a selection circuit, a feed generation circuit and a distribution circuit, control to: receive, at the interface circuit, from each computing device, a market data update message; selectively route, at the selection circuit, a market data update message received at the interface circuit over a first path or a second path, based on an asset type indicated in the market data update message, in which the second path extends external to the at least one programmable integrated circuit; generate, at the feed generation circuit, for a first market data update message received over the first path from the selection circuit, based on filter information, at least one first distribution message; and receive at the distribution circuit, from the feed generation circuit, the at least one first distribution message for the first market data update message and, from external to the at least one programmable integrated circuit, at least one second distribution message for a second market data update message routed from the selection circuit over the second path; and cause, at the distribution circuit, the at least one programmable integrated circuit to output the at least one first distribution message and the at least one second distribution message respectively to at least one first client device of a plurality of client devices.

### BRIEF DESCRIPTION OF THE DRAWINGS

FIG. 1 is a block diagram of an exemplary computing apparatus, according to the present disclosure.

FIG. 2 is a block diagram of an exemplary system, according to the present disclosure.

FIGS. 3A, 3B, 3C, 3D and 3E illustrate an exemplary high level flow diagram of an exemplary method of processing market data update messages, according to asset type thereof, by software processing and a programmable hardware device and publishing market data indicated in the market data update messages to subscribers, according to the present disclosure.

### DETAILED DESCRIPTION

The technology of the present disclosure relates to, by way of example, a computer and networking architecture that may control processing market data update messages indicating market data events, by circuitry of a programmable hardware device of a computing platform or a processor executing software instructions where the processor is of the computing platform and external to the programmable hardware device, based on an asset type of a market data event indicated in a market data update message, to generate, based on filter information, distribution messages of respective market data events for clients permissioned to receive event data of a market data event, and publication of the distribution messages from the programmable hardware device respectively to the client devices. In one embodiment, the distribution messages may be published with equalization of network latencies associated with transmission of the distribution messages to respective client devices, to ensure simultaneous or substantially simultaneous receipt of filtered event data of a same market data event at the client devices.

In one embodiment, a computing system may receive a market data update message of a market data event, for example, asset trading details of an order to trade of an asset, such as an equity, a bond or cryptocurrency, cancelation of an existing order to trade an asset, submission of a new order to trade an asset or matched orders to purchase and sell a financial instrument, at an interface circuit of a programmable hardware device (PHD), for example, a reprogrammable logic device such as a field programmable gate array (FPGA); selectively, by a selection circuit of the PHD, route the market data update message, based on asset type indicated in the market data update message, over a first path within the PHD to a feed generation circuit of the PHD, or over a second path extending from the PHD to a processing device of the computing system, where the processing device is external to the PHD and includes a plurality of processors; and receive, at a distribution circuit of the PHD, at least one first distribution message for a first market data update message generated at the feed generation circuit and at least one second distribution message for a second market data update message generated by at least one of the processors of the processing device, where the distribution circuit causes output of the at least one first and second distribution messages from the PHD to client devices of respective users permissioned to receive the at least one first and second distribution messages, desirably with network latency equalization that provides for fairness in publication of market data events to the permissioned users which are subscribers to a market data publication service implemented by the computing system. The market data update messages may be from event sources, such as a matching engine or asset trading exchange, where each market data event has an event time corresponding to a time of a system clock of the computing system when event data of the market data event is transmitted to the computing system in a market data update message. The at least one first and second distribution messages may be generated based on filter information, and contain filtered event data of a respective market data event for respective permissioned users. In one embodiment, the distribution circuit may determine distribution times for the at least one first and second distribution messages to provide that distribution messages for a same market data event may be received at the same or substantially the same time at client devices respectively of users permissioned to receive event data of the same market data event. In one embodiment, the distribution times for the at least one first and second distribution messages may be a function of the event times of the respective market data events, hold delays for the client devices respectively to which the distribution messages are for transmission, and network latency offsets associated with transmission of the distribution messages to respective client devices. In one embodiment, the network latency offsets may include propagation delay offsets that equalize differences in propagation delays associated with communication paths extending from the PHD respectively to the client devices and serialization offsets that equalize differences in serialization delays associated with transmission, from the PHD onto communication paths, of distribution messages for a respective market data event including filtered event data having different byte sizes.

In one exemplary embodiment, a computing system may include at least one FPGA configured according to configuration information, and a processing device external to the at least one FPGA and including a plurality of processors. The configuration information may indicate subscribers to a market data publication service of the computing system, and hardware interconnections within the at least one FPGA that facilitate generating and routing to a distribution circuit within the at least one FPGA of first distribution messages containing filtered event data of a market data event generated at a feed generation circuit of the at least one FPGA. Processors of the processing device may execute software instructions that facilitate generating second distribution messages containing filtered event data of a market data event and routing the second distribution messages to the distribution circuit. The configuration information may indicate feeds on which to route the first distribution messages to the distribution circuit and feeds on which to route second distribution messages respectively from the processors of the processing device to the distribution circuit, and data paths on which to route the first and second distribution messages respectively to client devices of subscribers permissioned to receive the first and second distribution messages.

The at least one FPGA may control provisioning memory of the at least one FPGA to store a market data update message received at an interface circuit of the at least one FPGA, and to be made available to store another market data update message received at the interface circuit, immediately following routing of a first market data update message, previously stored in the memory of the at least one FPGA, on a path extending external to the at least one FPGA for processing at the processing device of the computing system.

In one exemplary embodiment, the at least one FPGA may control storing, in memory of the at least one FPGA, an order book for a client reflecting market data events indicated in distribution messages generated at the at least one FPGA. In addition, the processing device may control storing, in memory of the processing device, an order book for a client reflecting market data events indicated in distribution messages generated at a processor of the processing device. The order books implemented at the at least one FPGA and the processing device desirably may have a same or similar format.

In one embodiment, a computing system may include a single FPGA and a processing device external to the FPGA and including processors. The FPGA may include an interface circuit, a selection circuit, a feed generation circuit, a distribution circuit and a plurality of output circuits. A computing device as a matching engine, a trading exchange or like event source may cause transmission to the computing system of a market data update message including event data of a market data event and an event time for the market data event, where the event time is based on a time of a system clock of the computing system when the market data update message is transmitted to the computing system. The market data update messages may be received at the interface circuit. The selection circuit may, based on an asset type indicated in the market data update messages, selectively route the market data update messages to the feed generation circuit or the processing device. The feed generation circuit may (i) based on filter information, generate first distribution messages containing filtered event data of a market data event respectively for one or more of the subscribers permissioned to receive the filtered event data of the market data event, and (ii) based on configuration information, route the first distribution messages respectively for the one or more subscribers in feeds to the distribution circuit. The filter information may indicate permissioned users that can receive event data for a market data event indicated in a market data update message. In addition, the feed generation circuit may store, in a memory of the FPGA, in an order book for a client, market data reflecting market data update events indicated in the first distribution messages. The processing device may receive a market data update message from the selection circuit, and based on the filter information, cause one or more of the processors to process the market data message to generate second distribution messages containing filtered event data of the market data event indicated in the market data update message. In addition, the processing device may store, in a memory of the processing device, in an order book for a client, market data reflecting market data events indicated in the second distribution messages, and route the second distribution messages over respective feeds to the distribution circuit. The distribution circuit may route the first and second distribution messages respectively to the output circuits, in accordance with the configuration information. The output circuits may be communicatively coupled over communication paths respectively to client devices of subscribers permissioned to receive the distribution messages routed to the respective output circuits. The distribution circuit may determine distribution times for respective distribution messages for a specific market data event, where a distribution time for a distribution message is based on the event time of the specific market data event, a hold delay for the distribution message, and a network latency offset for the distribution message. In addition, the distribution circuit may determine whether distribution times for respective distribution messages for the specific market data event are satisfied, based on comparisons of a current time of the system clock with the distribution times. When a given distribution time for a given distribution message is determined to be satisfied, the distribution circuit may cause a given output circuit, to which the given distribution message was routed, to transmit the given distribution message to a given client device that is coupled to the given output circuit over a given communication path. In one embodiment, a network latency offset may include a propagation delay and/or a serialization offset, as discussed above.

It is to be understood that the features in accordance with the present disclosure may be applied to publishing event data other than asset trading data from a computing system to respective client devices in applications requiring faster processing of certain types of event data than other types of event data based on the certain types of event data being received at a computing platform at much higher rates, such as about every 1 microsecond, than the other types of event data, which may be received at about once every 10 microseconds, where the publishing desirably provides for simultaneous or substantially simultaneous receipt of filtered event data of a same event at multiple client devices in applications such as, for example, real time streaming of video or audio data, such as in interactive multi-player games, or event data from sensors, such as sensors in an internet of things (“IOT”) network including health device sensors, traffic device sensors, etc.

The present disclosure may be implemented using a combination of computer hardware and computer software to form a specialized machine capable of performing operations. Embodiments of the present disclosure may be performed utilizing a combination of central processing units (CPUs), physical memory, physical storage, electronic communication ports, electronic communication lines and other computer hardware. The computer software may include at least a computer operating system and specialized computer processes described herein.

In the present disclosure, certain specific details are set forth to provide a thorough understanding of various disclosed embodiments. However, one skilled in the relevant art will recognize that embodiments may be practiced without one or more of these specific details, or with other methods, components, etc. In other instances, well known structures associated with an electronic trading system have not been shown or described in detail to avoid unnecessarily obscuring descriptions of the embodiments.

The aspects, features and advantages of the present disclosure will be appreciated when considered with reference to the following description of examples and accompanying figures. In describing the exemplary embodiments of the disclosure illustrated in the drawings, specific terminology will be used for the sake of clarity. However, the disclosure is not intended to be limited to the specific terms used.

### Example Systems

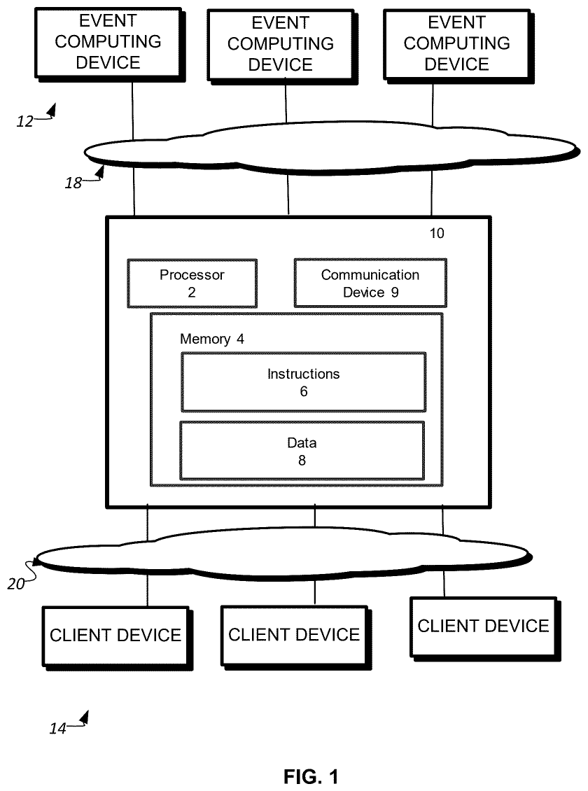

FIG. 1 illustrates a block diagram of an exemplary computing apparatus 10, in accordance with the present disclosure. The computing apparatus 10 may be communicatively coupled to a plurality of computing devices 12 as market data event sources (event computing devices), from which market data of a market data event may be transmitted as a market data update message to the computing apparatus 10. The market data event may include, for example, order data describing an order to purchase or sell a financial instrument received or an electronic trade executed at a computing device 12 serving as an electronic asset matching engine and/or a trading exchange. In addition, the computing apparatus 10 may be communicatively coupled with a plurality of computing devices 14 (client devices) of respective users as subscribers to a market data event publication service of the computing apparatus 10. In one embodiment, the computing apparatus 10 may be configured to implement a market data event publication service that, based on filter information indicating event information of a market data event that may or may not be published to a specific subscriber as a permissioned user, causes each client device of a user permissioned to receive at least a portion of event data of a same market data event, to receive from the computing apparatus 10, at the same time or substantially the same time, at least a portion of the event data for the same market data event.

In accordance with the present disclosure, the computing apparatus 10 may perform processing functions that control processing a market data update message based on asset type of a market data event indicated in the market update data message, such that market data update messages having an asset type associated with a fast moving market, such as benchmark instruments including on-the-run U.S. treasuries, for which many market data events occur in very short periods of time, such as 1 every microsecond, are selectively routed to a programmable hardware device (PHD), such as an FPGA, with circuitry having high speed processing capabilities, such as about a 10 GB line rate, and market data update messages having an asset type associated with slower moving markets, such as off-the-run U.S. treasuries or other low-liquidity assets, for which comparably less market data events occur over longer periods of time, such as once every 10 microseconds, are selectively routed to a processing device external to the PHD and at which processing is by execution of software instructions by processors having slower speed processing capabilities than the PHD. The PHD and the processing device may both implement order books for respective clients that subscribe to a market data publication service of the computing apparatus 10, where the order books respectively are updated based on the market data update messages that are processed. In addition, the PHD and the processing device may generate distribution messages for market data events, based on filter information indicating subscribers permissioned to receive at least some portion of event data for a market data event indicated in a market data update message. The PHD may cause output of the distribution messages generated at the PHD, and also the distribution message generated at the processing device and provided to the PHD, to computing devices 14 of respective permissioned users, desirably equalizing differences in network latencies associated with transmitting distribution messages containing respective filtered event data for the same market data event from the PHD over respective communication paths to the computing devices 14. The selective routing of market data update messages to circuitry in the PHD or to the processing device external to the PHD, based on asset type, advantageously provides that market data update messages for asset types likely to be received in bursts at an interface circuit of the PHD may be processed with low latency in the PHD, because memory and processing resources of the PHD are allocated to process market data update messages of such asset types, whereas market data update messages for asset types likely to be received at lower rates at the interface circuit are processed at relatively slower processing rates at processors external the PHD. In addition, the transmission, from a distribution circuit of the PHD, of the distribution messages generated at the PHD and the processing device ensures low latency publication to client devices of permissioned subscribers, with minimized usage of communication network bandwidth, processing and memory resources, as described in detail below.

Referring to FIG. 1, the computing apparatus 10 may be in the form of a computing device that includes one or more processors 2, one or more memory 4 and other components commonly found in computing devices. In one embodiment, the one or more processors 2 may include or be configured to operate as one or more servers.

The memory 4 may store information accessible by the one or more processors 2, including instructions 6 that may be executed by the one or more processors 2.

The one or more processors 2 may include an architecture configured to include a programmable hardware device (PHD) including a programmable integrated circuit or reprogrammable logic device, such as a field programmable field array (“FPGA”), an application specific integrated circuit (“ASIC”) or a system on chip (“SoCs”). In one embodiment, the architecture may be hardwired on a substrate. In one embodiment, the one or more processors 2 may include any type of processor, such as a CPU from Intel, AMD or Apple.

Memory 4 may also include data 8 that can be stored, manipulated or retrieved by the one or more processors 2. The data 8 may also be used for executing the instructions 6 and/or for performing other functions. The memory 4 may be any type of non-transitory media readable by the one or more processors, such as a hard-drive, solid state hard-drive, memory card, ROM, RAM, DVD, CD-ROM, write-capable, read-only memories, etc.

The instructions 6 may be any set of instructions capable of being read and executed by the one or more processors 2. The instructions may be stored in a location separate from the computing device, such as in a network attached storage drive, or locally at the computing device. The terms “instructions,” “functions,” “application,” “steps,” and “programs” may be used interchangeably herein. The instructions residing in a non-transitory memory may comprise any set of instructions to be executed directly (such as machine code) or indirectly (such as scripts) by processor 2. In this regard, the terms “instructions,” “scripts,” or “modules” may be used interchangeably herein. The computer executable instructions may be stored in any computer language or format, such as in object code or modules of source code. Furthermore, it is understood that the instructions may be implemented in the form of hardware, software or a combination of hardware and software and that the examples herein are merely illustrative.

Data 8 may be stored, retrieved and/or modified by the one or more processors 2 in accordance with the instructions 6. Such data may be stored in one or more formats or structures, such as in a relational or non-relational database, in a SQL database, as a table having many different fields and records, XLS, TXT, or XML documents. The data may also be formatted in any computing device-readable format. In some embodiments the data may be encrypted.

The computing apparatus 10 may include a communication device 9 configured to provide wired or wireless communication capabilities.

Referring to FIG. 1, in one embodiment, the computing apparatus 10 may be communicably interconnected with the computing devices 12 as matching engines or trading exchanges over a communication network 18, and the computing devices 14 of respective subscribers over a communication network 20. The communication network 18 may be a local area network (“LAN”), a wide area network (“WAN”) or the Internet, etc. The communication network 18 and intervening nodes thereof may use various protocols including virtual private networks, local Ethernet networks, private networks using communication protocols proprietary to one or more companies, cellular and wireless networks, HTTP and various combinations of the foregoing. The communication network 20 may be a communication network having predetermined network characteristics, such as bandwidth, communication protocol, communication paths and communication path lengths, and include a local area network (“LAN”), wide area network (“WAN”), virtual private network, local Ethernet network, a private network using a proprietary communication protocol proprietary or like network. In addition, the networks 18 and 20 may utilize a variety of networking protocols now available or later developed including, but not limited to, Transmission Control Protocol/Internet Protocol (TCP/IP) based networking protocols.

In one embodiment, the computing apparatus 10 may include a portion of the communication network 18, the communication network 20, one or more of the computing devices 12 and/or one or more of the computing devices 14. In one embodiment, a computing device 12 may include or be coupled to circuitry (an event circuit) from which a market data update message including event data for a market data event occurring at or reported to the computing device 12 is transmitted over the communication network 18 to a component of the computing apparatus 10.

FIG. 1 illustrates the components of the computing apparatus 10 as being single components, however, the components may comprise one or multiple programmable hardware devices such as FPGAs, processors, computers, computing devices or memories that may or may not be stored within the same physical housing. For example, the memory may be a hard drive or other storage media located in housings different from that of the computing apparatus 10. Accordingly, references to a programmable hardware device, processor, computer, computing device, or memory herein will be understood to include references to a collection of processors, computers, computing devices, or memories that may or may not operate in parallel. Further, although some functions described below are indicated as taking place on a single computing device having a single processor, various aspects of the subject matter described herein may be implemented by a plurality of computing devices in series or in parallel. For example, in one embodiment, functions performed by the computing apparatus 10 as described below may at least be partially performed at another computing apparatus having the same or similar components as the computing apparatus 10. In one embodiment, functions described herein as performed by the computing apparatus 10 may be distributed among one or more computing devices (servers) that operate as a cloud system.

Although only a single computing apparatus 10 (computer) is depicted herein, it should be appreciated that a computing apparatus in accordance with the present disclosure may include additional interconnected computers and programmable hardware devices, such as FPGAs. It should further be appreciated that computing apparatus 10 may be an individual node in a network containing a larger number of computers.

In one embodiment, the computing apparatus 10 may include all the components normally used in connection with a computer. For example, computing apparatus 10 may have a keyboard and mouse and/or various other types of input devices such as pen-inputs, joysticks, buttons, touch screens, etc., as well as a display, which could include, for instance, a CRT, LCD, plasma screen monitor, TV, projector, etc.

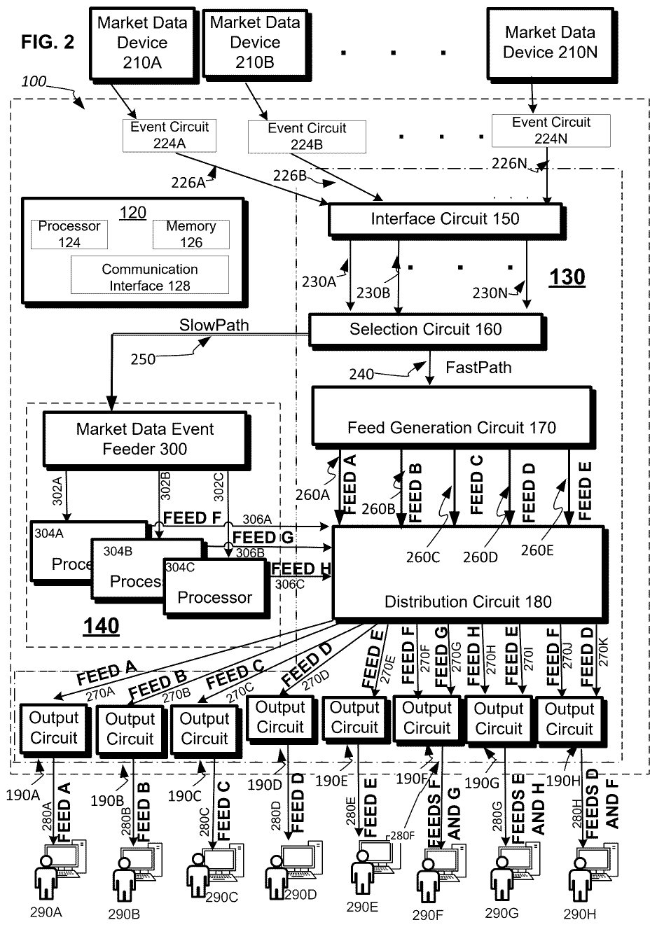

Referring to FIG. 2, in some embodiments, the computing apparatus 10 may be configured as a system 100 to implement specific functions and operations in accordance with the present disclosure. In one embodiment, the system 100 may be configured to implement a market data event publication service for market data events associated with asset trading. The market data events may be, for example, cancelation of an existing order or execution of a trade involving two orders, and include details of or relating to the order or trade, such as price, quantity, identity of a party that entered an order that was executed to generate a trade as a market data event, identification information of a trading exchange or matching engine as a computing device at which the market data event occurred, etc. In some embodiments, the system 100 may be programmed with programs to perform some or all of the functions and operations described herein.

Referring to FIG. 2, the system 100 may be implemented as a server including a controller 120, a programmable hardware device (PHD) 130 and a processing device 140. The processing device 140 may be external to the PHD 130. The controller 120 may include a processor 124, a memory 126 and a communication interface 128, and be coupled with the processing device 140 and the PHD 130. The memory 126 may be configured to store instructions to implement specific functions and operations, and data related to event data processing and distribution, in accordance with the present disclosure. The communication interface 128 may include components that provide network communication capabilities. In one embodiment, each of the components of the system 100 may include a processor and a memory including instructions that implement functions of the respective component, as described below.

In one embodiment, the PHD 130 may be configured as or to include a single FPGA or multiple FPGAs. The FPGA(s) may include at least a portion of the memory 126.

Configuration information for the system 100 may be stored in memory 126. The configuration information for the system 100 may indicate interconnections among the components and data paths in the FPGA of the PHD 130, interconnections between the processing device 140 and the PHD 130 and interconnections between the PHD 130 and specific client devices of subscribers to the market data publication service of the system 100 permissioned to receive distribution messages for market data events generated in the PHD 130 and the processing device 140. The subscribers may be, for example, traders or brokers.

For ease of reference and convenience, the disclosure herein that a component of the system 100 may perform a function or operation, is a disclosure that a processor or circuitry of the system 100 may perform or control the performance of the function or operation.

The PHD 130 may include an interface circuit 150, a selection circuit 160, a feed generation circuit 170, a distribution circuit 180 and output circuits 190A-190H. In one embodiment, specific functions and operations of the interface circuit 150, the selection circuit 160, the feed generation circuit 170, the distribution circuit 180 and the output circuits 190, in accordance with the present disclosure, are desirably executed in a single programmable hardware device, such as in an FPGA, although it is to be understood that some or all of the functions and operations may be executed in software.

In one embodiment, processor 124 may be communicatively coupled with and configured to control at least one or more of the components of the PHD 130 or the processing device 140.

The system 100 may be communicatively coupled with market data devices 210A-210B as computing devices, respectively via event circuits 224A, 224B . . . 224N of the system 100. In one embodiment, the event circuits 224 may be included at least partially within respective market data devices 210. The system 100 may include communication paths 226A, 226B . . . 226N communicatively coupling the interface circuit 150 with the event circuits 224A, 224B . . . 224N.

In one embodiment, the controller 120 may be communicatively coupled with the event circuits 224 and/or the market data devices 210.

The PHD 130 may include data paths 230A, 230B . . . 230N extending from the interface circuit 150 to the selection circuit 160. The selection circuit 160 may be communicatively coupled via a data path (FastPath) 240 to the feed generation circuit 170 and a data path (SlowPath) 250 to the processing device 140. The SlowPath 250, for example, may be PCIe bus or the like.

The PHD 130 may include data paths 260A, 260B, 260C, 260D and 260E extending from the feed generation circuit 170 to the distribution circuit 180, in accordance with the configuration information for the system 100. Each data path 260 may route a specific feed of distribution messages, which are for transmission to at least one specific client device, from the feed generation circuit 170 to the distribution circuit 180.

The processing device 140 may include a market data event feeder 300, processors 304A, 304B and 304C and data paths 302A, 302B and 302C extending from the market data event feeder 300 respectively to the processors 304A, 304B and 304C. It is to be understood that the processing device 140 may include more or less processors 304 communicatively coupled via respective data paths 302 with the market data event feeder 300. The processors 304A, 304B and 304C may be communicatively coupled via respective data paths 306A, 306B and 306C with the distribution circuit 180. Each data path 306 may route a specific feed of distribution messages, which are for transmission to at least one specific client device, from a processor 304 to the distribution circuit 180.

The PHD 130 may include data paths 270A, 270B, 270C, 270D and 270E extending from the distribution circuit 180 respectively to the output circuits 190A, 190B, 190C, 190D and 190E, data paths 270F and 270G extending from the distribution circuit 180 to the output circuit 190F, data paths 270H and 270I extending from the distribution circuit 180 to the output circuit 190G and data paths 270J and 270K extending from the distribution circuit 180 to the output circuit 190H. The output circuits 190A, 190B . . . 190H may be coupled over communication paths 280A, 280B . . . 280H respectively with computing devices 290A, 290B . . . 290H (client devices) of users as subscribers to a market data event publication service of the system 100.

Each output circuit 190 may be communicatively coupled over a communication path 280 to a single client device 290. A client device 290 may receive distribution messages over a communication path 280 which are from one or more feeds to the distribution circuit 180.

In one embodiment, the PHD 130 may include portions of the communication paths 226, the interface circuit 150, the selection circuit 160, the feed generation circuit 170, the data paths 230, 240, 260 and 270, the distribution circuit 180, the output circuits 190 and portions of the communication paths 280 configured as an FPGA.

The data paths 260 and the data paths 306 may be interconnected with the data paths 270 and the output circuits 290, according to the configuration information. The configuration information may indicate information on client devices 290 of respective subscribers to the market data event publication service; interconnections of the data paths 260 and 306 with the data paths 270 and the output circuits 190; and client devices 290 of respective subscribers which are coupled over communication paths 280 respectively to the output circuits 190. Based on the configuration information, in operation of the system 100, a distribution message for a given client device 290 may be routed over a predetermined data path 260 or 306, and then over a predetermined data path 270 to a predetermined output circuit 190, which transmits the distribution message only to the given client device 290.

In one embodiment, each communication path 280 may be a communication path independent of any other communication path 280.

In one embodiment, the controller 120 may be communicatively coupled with the computing devices 290 which are associated with a trader or broker.

In one embodiment, one or more of the computing devices 290 may be a laptop, desktop or mobile computing device, such as a smartphone or tablet. The one or more client devices may execute an “app” to interact with the system 100. The app, for example, may execute on a mobile device operating system, such as Apple Inc.'s iOS®, Google Inc.'s Android®, or Microsoft Inc.'s Windows 10 Mobile®, which provides a platform that allows the app to communicate with particular hardware and software components of the mobile device. For example, the mobile device operating system may provide functionalities for interacting with location services circuitry, wired and wireless network interfaces, user contacts, and other applications, where the functionalities include application programming interfaces (APIs) that enable communication with hardware and software modules executing outside of the app, such as included in the system 100. In one embodiment, a computing device 290 may, via the app executing on the computing device 290, be configured to communicate with the system 100 via the communication interface 128.

Each event circuit 224 may have communication capabilities and be configured to generate a market data update message containing event data of a market data event. The event data may be generated at a market data device 210, such as a matching engine or trading exchange associated with or including an event circuit 224. For example, the market data event may be a trade of an asset between first and second parties, and the event data of the market data event may include information identifying the asset, the first and second parties to the trade, the price of the asset in the trade, the size of the asset in the trade and a trading exchange at which the trade was executed. An event circuit 224 may be configured to transmit a market data update message containing event data of a market data event to the interface circuit 150, and include in the market data update message an event time for the market data event, where the event time corresponds to a time when the market data update message is transmitted from the event circuit 224.

In one embodiment, the controller 120 may be configured to include and control an electronic clock as a system clock of the system 100 that electronically times at increments of nanoseconds. Each event circuit 224 may be supplied with a current time of the system clock from the controller 120. An event circuit 224 may determine an event time of a market data update message, based on a time of the system clock when the market data update message is transmitted.

In one embodiment, an event circuit 224, or an event computing device associated with the event circuit 224, may include and operate a local electronic clock whose time is based on or corresponds to a time of the system clock of the system 100. In one embodiment, the time of the local electronic clock may be synchronized with the time of the system clock of the system 100. In one embodiment, the event time for a market data event may be determined based on a time of the local electronic clock when a market data update message indicating the market data event is transmitted from an event circuit 224.

In one embodiment, an event circuit 224 may set an event time for a market data event as the time of the system clock, or the time of a local clock thereof, when a last data byte of event data in a market data update message is transmitted from the event circuit. In one embodiment, the event circuit may include the event time in a data packet of the market data update message, such as in a data packet of a header or a payload of the market data update message.

As discussed below, the system 100 may utilize the current time of the system clock to control distribution of event data of a same market data event to multiple client devices based on the event time of the same market data event, with equalization of network latencies associated with transmission of distribution messages containing filtered event data of the same market data event to the respective client devices.

In one embodiment, a market data update message may have a Transmission Control Protocol (TCP), User Datagram Protocol (UDP), unicast or multicast message format. For example, an event circuit 224 may be a TCP circuit that generates and transmits an event stream containing a plurality of market data update messages, such as a TCP stream of market data update messages.

The interface circuit 150 may include communication capabilities and be configured to store, in memory of the PHD 130, a market data update message received over a communication path 226. In addition, the interface circuit 150 may route the market data update messages received on the communication paths 226 over respective data paths 230 extending to the selection circuit 160.

In one embodiment, the interface circuit 150 may, for a specific market data event received in a market data update message, determine a current time of the system clock when the market data update message is received (“event receipt time”) at the interface circuit 150. The interface circuit 150 may store in memory, such as memory of the PHD 130 or the memory 126, for each market data event received in a market data update message, an event receipt time. As discussed in detail below, the event receipt time for a specific market data event may be used to order distribution messages for respective market data events in a queue, which is used to control transmission of the distribution messages to client devices respectively of permissioned users.

The memory of the PHD 130 may store asset type information indicating asset types associated with processing at respectively the PHD 130 and processing device 140, which are hereinafter referred to as FastPath and SlowPath processing for ease of reference.

The selection circuit 160 may, from event data of a market data update message received over a data path 230 from the interface circuit 150, determine an asset type of a market data event indicated in the market data update message. The selection circuit 160 may be configured to retrieve asset type information from memory, compare the asset type of the market data update message with the asset type information and determine from the comparison whether the market data update message indicates an asset type associated with FastPath or SlowPath processing. Based on the asset type determination, the selection circuit 160 may selectively route the market data update message over the SlowPath 250 or the FastPath 240. When a market data update message is routed over the SlowPath 250, the PHD 130 advantageously may immediately provision, as free or available, memory of the PHD used to receive at the interface circuit 150, route over the data path 230 and process at the selection circuit 160, the market data update message that is routed over the SlowPath 250. The PHD 130 may, as a result, not perform further memory or processing operations involving a market data update message once it is routed over the SlowPath 250. Advantageously, memory and processing resources of the PHD 130 may be made available to receive and process other market data update messages from event circuits. Furthermore, memory and processing resources of the PHD 130 are not used to implement order books for clients for assets indicated in market data update messages routed over the SlowPath 250, because, as described below, the processing device 140 implements such order books using memory and processing resources of the processing device 140.

The feed generation circuit 170 may, for a specific market data event indicated in a market data update message received over the FastPath 240, based on filter information, generate a distribution message containing at least some portion of event data of the specific market data event, for at least one client device 290 respectively of at least one user permissioned to receive at least some portion of the event data of the specific market data event. The filter information, for example, may identify one or more users permissioned or not permissioned to receive certain event data describing a specific event or type of event. In one embodiment, a distribution message may include filtered event data, which is all or a portion of event data of a market data event, for at least one specific client device of at least one user permissioned to receive the filtered event data. The feed generation circuit 170 may generate a plurality of distribution messages for a specific market data event respectively for a plurality of client devices of respective permissioned users.

In one embodiment, a distribution message may include an event time of the market data event corresponding to the distribution message. In one embodiment, the event time of the market data event may be included as metadata in a distribution message for the market data event.

In one embodiment, the feed generation circuit 170 may generate, for a given distribution message, distribution information indicating one or more client devices respectively of one or more users permissioned to receive specific filtered event data for a specific market data event contained in the given distribution message.

In one embodiment, the filter information may be based on input information received by the system 100, such as from a client device 290 of a subscriber, or publication restriction information included in a market data update message from an event circuit 224. In one embodiment, the filter information may be stored in the memory 126, such as in a lookup table.

The feed generation circuit 170 may, for one or more client devices respectively of one or more users, generate a feed of distribution messages for respective market data events, according to the configuration information. Each feed may be for routing distribution messages that are for transmission only to one or more specific client devices. The distribution messages routed in a specific feed may include only filtered event data that a specific user or users for the specific feed is permissioned to receive, based on the filter information.

In an exemplary embodiment, the feed generation circuit 170, based on the configuration information, may route distinct feeds A, B, C, D and E of distribution messages containing filtered event data of distinct market data events or a same market data event, for client devices 290 of permissioned users respectively over data paths 260A, 260B, 260C, 260D and 260E to the distribution circuit 180.

The distribution messages for a same market data event in the respective feeds A, B and C may have different filtered event data and be for transmission to different subscribers at client devices 290A, 290B and 290C.

The market data event feeder 300 may be configured as circuitry and/or a processor that extracts data from a market data update message received over the SlowPath 250 and, from the extracted data, determines a specific market data event indicated in the market data update message. In addition, the market data event feeder 300 may be configured to determine, based on the filter information, one or more of the processors 304 at which to process the market data update message to generate a distribution message for the market data event for at least one subscriber. Based on the filter information, the market data event feeder 300 may provide the market data update message or event data of the market data event indicated in the market data update message, to one or more of the processors 304 over respective data paths 302.

The one or more processors 304 may be configured to each generate a distribution message for the market data update message, based on the filter information. The one or more processors 304 may route distribution messages generated thereat respectively over data paths 306 that extend into the PHD 130 and to the distribution circuit 180. In one embodiment, each processor 304 may be configured to perform operations and functions substantially similar to operations and functions performed by the feed generation circuit 170.

In an exemplary embodiment, for market data update messages A and B received over the SlowPath 250, the market data event feeder 300 may determine, from the filter information, that same event data of market data update message A may be published to client devices 290F and 290H. Based on the filter information, the market data event feeder 300 may provide the market data update message A or event data indicated in the market data update message A on data path 302A to the processor 304A. The processor 304A may execute instructions stored in memory, such as the memory 126, and which are in accordance with the filter information, to generate a distribution message A based on the market data update message A, and route the distribution message A on feed F over data path 306A to the distribution circuit 180. In addition, the market data event feeder 300 may determine, from the filter information, that event data of market data update message B may be published only to client device 290F. Based on the filter information, the market data event feeder 300 may provide the market data update message B on data path 302B to the processor 304B. The processor 304B may execute instructions stored in memory, such as the memory 126, and which are in accordance with the filter information, to generate a distribution message B based on the market data update message, and route the distribution message B on feed G over data path 306B to the distribution circuit 180.

In one embodiment, a given processor of the system 100, such as the processor 124, a processor of the PHD 130 or a processor of the processing device 140, may be configured to control processing of market data update messages at the processing device 140 by processors 304, to provide that the processors 304 process event data for different market data events indicated in respective market data update messages at a same time, to increase the speed at which distribution messages for respective market data events are generated at the processing device 140. In one embodiment, the given processor may determine when, for a first market data event indicated in a first market data update message received at the processing device 140, all processors 304 that are to process the first market data event have started processing the first market data event. When all the processors 304 that are to process the first market data event are determined to have started processing the first market data event, the given processor may make another (second) market data event available for processing by the processors 304 processing the first market data event. For example, when the processors 304A and 304C, which are to process the first market data event, are determined to have started processing the first market data event, the second market data event, which is also to be processed by the processors 304A and 304C, becomes available for the processor 304A or 304C to process after the processor 304A or 304C completes processing of the first market data event. Processing of the first market data event at a processor 304 may be complete upon the processor 304 generating a distribution message for the first market data event. The given processor further may determine when all processors 304 that have been controlled to generate distribution messages for the first market data event have generated distribution messages, and, when all such processors 304 are determined to have completed generating the distribution messages for the first market data event, the processors 304 may be controlled to route, desirably simultaneously, the distribution messages therefrom respectively on feeds over data paths 306 to the distribution circuit 180.

The distribution circuit 180 may receive feeds of distribution messages routed on feeds A, B, C, D and E from the feed generation circuit 170 respectively over the data paths 260A, 260B, 260C, 260D and 260E, and feeds of distribution messages routed on feeds F, G and H from the processing device 140 respectively over the data paths 306A, 306B and 306C. The distribution circuit 180 may route distribution messages over data paths 270A, 270B 270K to output circuits 190A, 190 . . . 190H, in accordance with the configuration information.

An output circuit 190 may include network communication capabilities and be configured to transmit a distribution message over a communication path 280 to a client device 290, in accordance with the configuration information. An output circuit 190 may transmit a distribution message received over a data path 270 only to a client device 290 to which a communication path 280 extends from the output circuit 190, according to the configuration information. For example, the output circuit 190A may transmit a distribution message routed on a feed A over data path 260A and received over the data path 270A, only to a client device 290A over the communication path 280A. In addition, the output circuits 190D and 190H may transmit distribution messages routed on a feed D over data path 260D, and received over the data paths 270D and 270K respectively, only to client devices 290D and 290H over the communication paths 280D and 280H. Further, the output circuit 190F may transmit distribution messages routed on feeds F and G respectively over data path 306A and 306B and received over the data paths 270F and 270G, only to a client device 290F over the communication path 280F.

Also in one embodiment, according to the configuration information, a single (same) distribution message, which is for client devices of respective multiple permissioned subscribers, may be routed in a feed to the distribution circuit 180, replicated by the distribution circuit 180, and the distribution circuit may route the replicated distribution messages by fanout to output circuits 190 that respectively are for transmitting the distribution messages only to specific client devices. For purposes of this disclosure, a given distribution message and each distribution message that is a replica of the given distribution message are considered to be a same distribution message, in that each of the given distribution and the replica distribution messages contains the same filtered event data for a market data event and optionally the event time for the market data event. For example, the distribution circuit 180 may replicate a distribution message in the feed D on the data path 260D and route, by fanout, the distribution messages resulting from the replication of the distribution message in the feed D, over the data paths 270D and 270K respectively to the output circuits 190D and 190H for transmission respectively to the client devices 290D and 290H.

The distribution circuit 180 may cause transmission of distribution messages from output circuits 190 to respective client devices 290, based on distribution times respectively of the distribution messages.

The distribution circuit 180 may be configured to determine, for each market data event indicated in distribution messages received at the distribution circuit 180, distribution times respectively for distribution messages for the market data event. Distribution times for respective distribution messages for a same market data event may be determined to provide that each distribution message containing filtered event data for a same market data event is received from the system 100 at a same or substantially the same time at each computing device 290 of a user permissioned to receive filtered event data of the same market data event.

In one embodiment, distribution times for distribution messages may be determined to equalize differences in network latencies associated with transmission of distribution messages including filtered event data for the same market data event from respective output circuits 190, over communication paths 280, to client devices 290. The distribution times of respective distribution messages may be based on network latency offsets including propagation delay offsets and serialization offsets.

In one embodiment, the memory 126 may include a lookup table or equivalent that indicates, for each distribution message to be transmitted to a client device, a distribution time, a network latency offset, a propagation delay offset, a serialization offset, an output circuit 190 for transmission of the distribution message and a client device 290 to receive the distribution message. For example, the memory 126 may indicate that a distribution message for transmission from the output circuit 190A to a client device 290A has a network latency offset of −19 nsec, a serialization offset of −10 nsec and a propagation delay offset of −9 ns.

In one embodiment, for a distribution message on a feed received at the distribution circuit 180 which is for transmission to a single client device, the distribution circuit 180 may route the distribution message from a data path 260 or 306, without delay, on to a data path 270 extending to an output circuit 190 that is communicatively coupled to the single client device. For example, the distribution messages in the feeds A, B and C on data paths 260A, 260B and 260C may be routed, without delay, by the distribution circuit 180 respectively over data paths 270A, 270B and 270C to the output circuits 190A, 190B and 190C.

In one embodiment, for a distribution message on a feed received at the distribution circuit 180 which is for transmission to multiple client devices, the distribution circuit 180 may simultaneously route, by fanout, distribution messages, which are replicas of the distribution message received at the distribution circuit 180, at a predetermined routing time for the distribution messages, on to data paths 270 extending to output circuits 190 that are communicatively coupled respectively to the multiple client devices. The predetermined routing time may be based on a largest network latency offset among the network latency offsets associated with transmission of the distribution messages from the output circuits 190 to the respective multiple client devices 290. In one embodiment, the predetermined routing time may be a sum of an event time for the distribution message on the feed received at the distribution circuit 180 which is for transmission to the multiple client devices, a hold delay for the distribution message on the feed, and a maximum network latency offset of the network latency offsets associated with transmission of the replica distribution messages respectively from the output circuits 190. For example, the distribution circuit 180 may route two distribution messages, which are replicas of a distribution message in the feed D on data path 260D, simultaneously, at a predetermined routing time for the two distribution messages, over data paths 270F and 270K respectively to the output circuits 190D and 190H, when the distribution circuit 180 determines a current time of the system clock is equal to or after the predetermined routing time for the two distribution messages.

In one embodiment, the communication paths 280 may constitute a high-speed signal transmission medium, such as optical fiber, electrical cable or the like, having predetermined network properties, which are based on a type of transmission medium of the communication path. Also, different communication protocols may be used to transmit signals on respective communication paths. The network properties and length of a predetermined communication path, and a communication protocol used to transmit a data signal, such as a distribution message containing filtered event data, along the communication path, may determine a propagation delay associated with transmitting the distribution message from an output circuit 190 over a communication path 280 to a respective client device 290. Differences in the network properties and lengths of the respective communication paths 280, and communication protocols used to transmit data signals on the respective communication paths 280, may result in different propagation delays for the respective communication paths 280 extending from the output circuits 190 to respective client devices 290.

In one embodiment, the memory 126 may include communication path information indicating characteristics of a predetermined communication path that extends from a specific output circuit 190 over a predetermined communication path 280 to a predetermined client device 290 of a subscriber. The processor 124 may, based on the communication path information, determine a propagation delay offset associated with transmission of a distribution message from a specific output circuit 190 to a specific client device 290. A propagation delay offset may be determined as a time difference between a time of transmission of a distribution message from the computing system, such as from an output circuit 190, over a communication path 280, to a client device 290, and a time the distribution message is received at the client device 290.

In an embodiment, propagation delay offsets may be utilized to equalize differences in the propagation delays associated with communication paths 280 extending to respective client devices 290, to advantageously provide that filtered event data of, for example, a same asset trading event, may be received at a same or substantially the same time at the respective client devices 290.

The processor 124 may store in the memory 126 propagation delay offsets for communication paths 280 associated with respective output circuits 190 and client devices 290.

In one embodiment, the distribution circuit 180 may determine a serialization offset for each distribution message for a specific market data event. Differences in serializations delays may exist for distribution messages of the same market data event, based on filtered event data for the same market data event having different byte sizes in respective distribution messages. The serialization offsets of respective distribution messages for a specific market data event may correspond to differences in byte sizes of filtered event data for the specific market data event. Advantageously, the serialization offsets for respective distribution messages for a same market data event may be determined and utilized by the system 100 to equalize differences in serialization delays associated with transmitting distribution messages by the output circuits 190 respectively on to the communication paths 280.

In one embodiment, the distribution circuit 180 may determine, for each distribution message, a byte size of the distribution message, namely, a byte size of filtered event data of the distribution message and, when the distribution message includes data of an event time, a byte size of the data of the event time. The distribution circuit 180 may determine the byte size of a distribution message when the distribution message is received at the distribution circuit 180. The distribution circuit 180 may store a byte size for each distribution message in the memory 126.

In one embodiment, the feed generation circuit 170 may determine the byte size of a distribution message when the distribution message is generated at the feed generation circuit 170, and store the byte size for the distribution message in the memory 126.

In one embodiment, a processor 304 may determine the byte size of a distribution message that it generates, and store the byte size for the distribution message in the memory 126.

In one embodiment, serialization offsets for distribution messages for a same event may be determined to equalize differences in serialization delays, and provide that, for a same market data event, a last data byte of filtered event data for the same market data event in respective distribution messages transmitted from the system 100 may be received at the same or substantially the same time at respective client devices. In one embodiment, a serialization offset for a distribution message may be equal to a size in data bytes of the distribution message multiplied by a ByteTransmission rate at which the system 100 transmits a distribution message from an output circuit 190 on to a communication path 280. In one example, the distribution message may include a header having a first data byte size and a payload having a second data byte size of the filtered event data. The serialization offset for a distribution message may be equal to: −(first data byte size of header+second data byte size of filtered event data in payload)*Bytetransmission rate.

In one embodiment, the feed generation circuit 170, a processor 304 or the distribution circuit 180 may determine, and store in the memory 126, a serialization offset for a distribution message for a specific market data event.

In one embodiment, the network latency offsets used to determine distribution times for distribution messages for a specific market data event may include propagation delay offsets and not include serialization offsets, to provide that each client device of a permissioned user receives a first data byte of a distribution message containing filtered event data of the specific market data event, at a same or substantially the same time.

In one embodiment, the distribution circuit 180 may be configured to determine a distribution time for a distribution message that is equal to a sum of an event time for a market data event corresponding to filtered event data in the distribution message, a hold delay for the distribution message and a network latency offset for the distribution message. The hold delay may be configurable for each specific feed of distribution messages routed from the feed generation circuit 170 and the processing device 140. For example, the hold delays for respective feeds of distribution messages routed on data paths 260A and 260B may be different. In one embodiment, a hold delay for each of the feeds routed to the distribution circuit 180 may be about 40 microseconds.

In one embodiment, a time interval from when a market data update message is routed from the selection circuit 160 on the SlowPath 250 and when all distribution messages generated in the processing device 140 for a market data event indicated in the market data update message are received at the distribution circuit 180 is about 2-5 microseconds.

In one embodiment, a time interval from when a market data update message is routed from the selection circuit 160 on the FastPath 240 and when all distribution messages generated in the feed generation circuit 170 for a market data event indicated in the market data update message are received at the distribution circuit 180 is less than about 1 microsecond.

The distribution circuit 180 may, continuously or at a preset time interval, determine a current time of the system clock, and compare a distribution time for a distribution message with the current time of the system clock. The distribution circuit 180 may determine that a distribution time is satisfied, when the current time of the system clock is the same as or after the distribution time. When the distribution time for a distribution message is determined to be satisfied, the distribution circuit 180 may cause transmission of the distribution message from an output circuit 190.

An output circuit 190 may have network communication capabilities and be configured to transmit a distribution message using a predetermined message format. In one embodiment, the transmission of a distribution message by an output circuit 190 may include reading, from a memory in the FPGA of the PHD 130, filtered event data of the distribution message received from the distribution circuit 180. In one embodiment, an output circuit 190 may be configured to implement Internet Protocol (IP) multicast, for example, using a User Datagram Protocol (UDP), Unicast or any messaging protocol that may provide for data transmission of a distribution message to one or more client devices 290. In one embodiment, an output circuit 190 may transmit a distribution message in a message format required by a client device 290 to which the output circuit 190 is coupled over a communication path 280, as indicated in the configuration information.

In one embodiment, an output circuit 190 may be configured as or include a TCP server circuit. In one embodiment, a distribution message may be transmitted using a binary market protocol format, such as Financial Information exchange (FIX®) protocol, or a multicast message format. In one embodiment, a communication path 280 between the output circuit 190 and a computing device 290 may be configured to facilitate communication using a Point to Point FIX protocol, or any other protocol.

In one embodiment, a distribution message for a market data event may be transmitted with a message format that is same as or different from a message format of a market data update message from which filtered event data in the distribution message is determined.

In one embodiment, the distribution circuit 180 may be configured to generate a queue in a memory, such as the memory 126. The queue may representatively indicate market data events corresponding to the filtered event data in distribution messages received at the distribution circuit 180, and, for each market data event, each distribution message to be transmitted to a client device including a distribution time for the distribution message. The distribution circuit 180 may remove a distribution message from the queue, when the distribution time for the distribution message is determined to be satisfied.

In one embodiment, based on the event times indicated, for example, in the metadata of the distribution messages containing first and second filtered event data for first and second market data events, the distribution circuit 180 may have the queue list, in chronological order in accordance with the respective first and second event times of the first and second market data events, distribution messages for the first market data event followed by distribution messages for the second market data event.

In one embodiment, for each market data event in the queue, the distribution circuit 180 may be configured to order all the distribution messages for the market data event chronologically based on the distribution times respectively.

In one embodiment, the system 100 may be configured to operate in an event time priority mode for publication of market data events. In the event time priority mode, the distribution circuit 180 may in chronological order, for each market data event in the queue, determine whether a distribution time of a distribution message for the market data event is satisfied, based on comparison of the distribution time with a current time of the system clock. In addition, in the event time priority mode, the distribution circuit 180 may cause all distribution messages for a specific market data event in the queue to be transmitted from output circuits 190, before any distribution message for another market data event chronologically next in the queue, in other words, having an event time next after the event time of the specific market data event, is caused to be transmitted from an output circuit 190.

In one embodiment, the system 100 may be configured to operate in a distribution time priority mode for publication of market data events. In the distribution time priority mode, the distribution circuit 180 may cause transmission of distribution messages for respective market data events from output circuits based on respective distribution times, without regard to whether all distribution messages for a specific market data event listed in the queue have been transmitted. For example, a second distribution message for a second market data event may be caused to be transmitted before all first distribution messages for a first market data event are transmitted, which may occur when there is a large difference between byte sizes of filtered event data respectively for the first and second distribution messages, or when there is a large difference between propagation delay offsets for client devices respectively to which the first and second distribution messages are for transmission.

In one embodiment, the system 100 may operate in an event priority mode or a distribution time priority mode based on a default setting for the system 100, or based on an instruction, for example, received by the system 100 over a communication network from an external computing device.

In one embodiment, where two or more different market data events have a same event time, the distribution circuit 180 may order the different market data events, with their respective distribution messages, one immediately after another in the queue, chronologically based on event receipt times of the different market data events, assuming the event receipt times are different. In one embodiment, where two or more different market data events have a same event time and same event receipt time, the different market data events may be ordered in the queue chronologically based on a current time of the system clock when processing of a distribution message for a specific market data event received at the distribution circuit 180 commences. For example, when first and second market data events have a same event time and same event receipt time, and processing of any distribution message for a first market data event received at the distribution circuit 180 commences by the distribution circuit 180 before processing of any distribution message for a second market data event received at the distribution circuit 180 commences, the first market data event with its distribution messages is listed in the queue preceding the second market data event with its distribution messages.

In one embodiment, where two or more distribution messages for a same market data event are determined to have the same distribution times, the distribution circuit 180 may, for the same market data event, order the distribution messages one immediately after another in the queue, chronologically based on a current time of the system clock when processing of any of the two or more distribution message received at the distribution circuit 180 commences by the distribution circuit 180. For example, when first and second distribution messages for a same market data event have the same distribution times, and processing of the first distribution message for the same market data event commences by the distribution circuit 180 before processing of the second distribution message for the same market data event commences, the first distribution message is listed in the queue preceding the second distribution message.

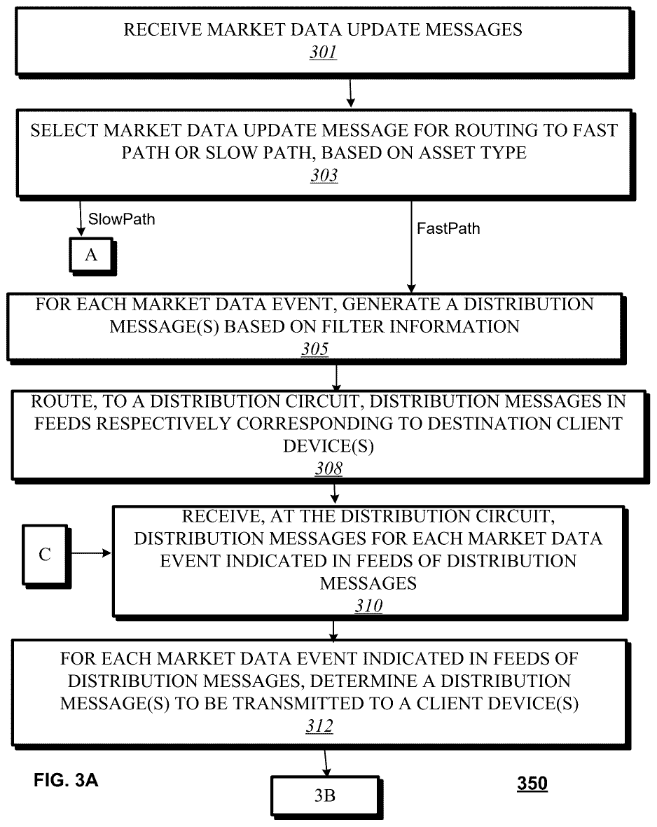

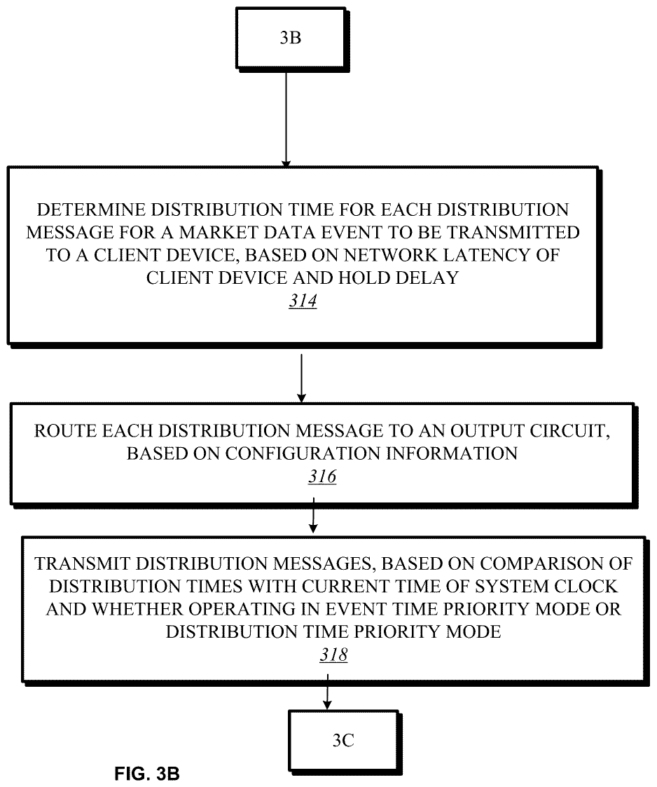

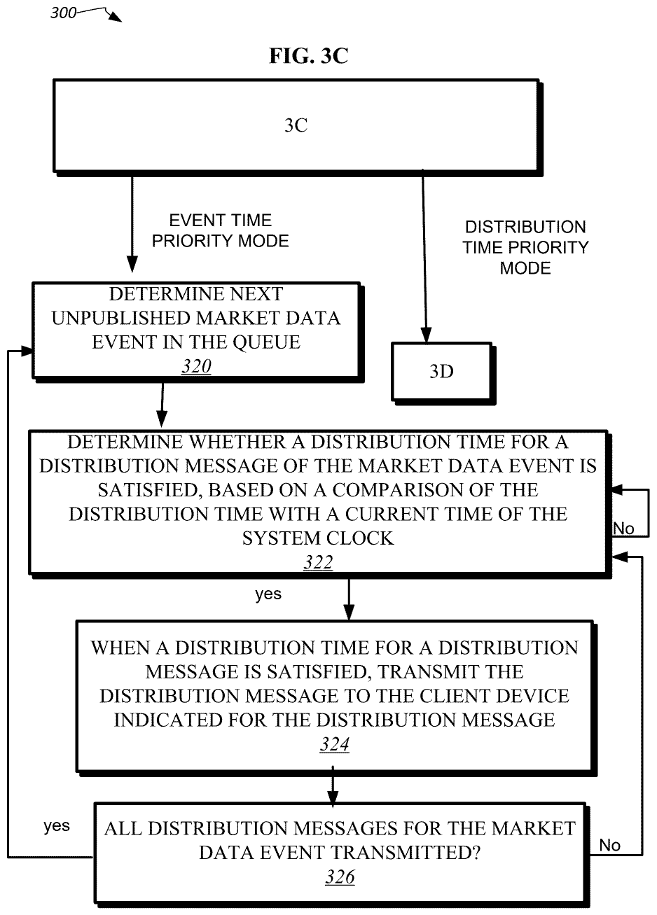

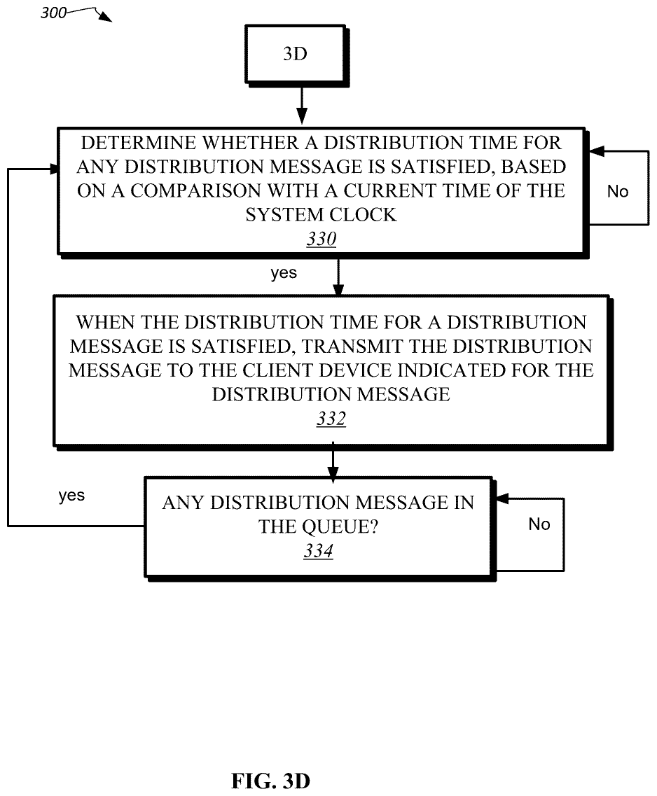

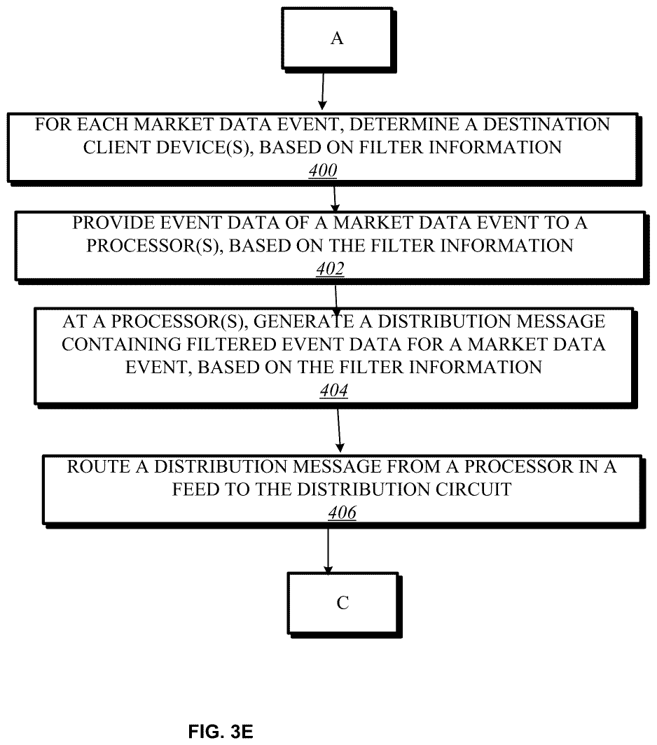

In one embodiment, as discussed below in connection with FIGS. 3A, 3B, 3C, 3D and 3E, for a specific instance of a comparison of a current time of the system clock with distribution times of respective distribution messages in the queue, the distribution times of two or more distribution messages for a same market data event or a different market data event may be determined to be satisfied. For this comparison instance, when the two or more distribution messages are for respective different client devices, the distribution circuit 180 may cause simultaneous or substantially simultaneous transmission of the distribution messages from output circuits 190 on to communication paths 280 respectively extending to the different client devices.

In one embodiment, the distribution times of two or more distribution messages for respective different market data events may be determined to be satisfied based on an instance of a comparison with a current time of the system clock. For this comparison instance, when at least two of the distribution messages are for the same client device, the distribution circuit 180 may cause successive transmission of the at least two of the distribution messages from a same output circuit 190, in chronological order based on event times of the at least two of the distribution messages.

In one embodiment, for a distribution message on a feed received at the distribution circuit 180 which is for transmission to a single client device, the distribution circuit 180 may route the distribution message from a data path 260 or data path 306, without delay, on to a data path 270 extending to an output circuit 190 that is communicatively coupled to the single client device. For example, the distribution messages in the feeds A, B and C on data paths 260A, 260B and 260C may be routed, without delay, by the distribution circuit 180 respectively over data paths 270A, 270B and 270C to output circuits 290A, 290 and 290C.

In one embodiment, the distribution circuit 180 may cause simultaneous transmission of distribution messages including filtered event data of a same market data event, from several output circuits 190 to respective client devices 290. In one embodiment, the output circuits 190 may be caused to transmit distribution messages for a same market data event over communication paths 280 at different times, in accordance with the distribution times thereof, to provide that respective filtered event data of the same market data event is received at a same or substantially the same time by respective client devices 290.

### Example Methods

For purposes of illustrating the features of the present disclosure, a high level block diagram of an exemplary process 350, as shown in FIGS. 3A, 3B, 3C, 3D and 3E, is described below in connection with operations performed at components of the system 100. The process 350 may selectively process market data update messages in circuitry of a PHD of the system 100, or at one or more processors of a processing device of the system 100 that executes software instructions and where the processing device is external to the PHD, to generate distribution messages containing at least some portion of event data of a market data event indicated in a market data update message, based on filter information indicating event data of the market data event that may or may not be published to client devices of respective subscribers to a market data event publication service of the system 100, and publish the distribution messages to the client devices of respective subscribers, with minimal processing latency and desirably equalizing any differences in network latencies associated with transmission of distribution messages respectively to the client devices.

In an exemplary embodiment of the system 100, the process 350 may control: receiving, at the PHD 130, market data update messages from respective computing devices as market data update sources, where each market data update message indicates a market data event and an event time of the market data event, and where the event time corresponds to a time of a system clock of the system 100 when the market data update message is transmitted to the system 100; selectively routing, by the PHD 130, based on an asset type indicated in a market data update message, the market data update message over a first path within the PHD 130 or a second path extending external to the PHD 130; generating, at the PHD 130, for a first market data update message routed over the first path, a first distribution message based on filter information; receiving, at a distribution circuit of the PHD 130, the first distribution message, which is routed within the PHD 130 to the distribution circuit, and, from external the PHD 130, a second distribution message determined from a second market data update message routed over the second path to a processing device 140 external to the PHD 130 and at which a processor 304 thereof generates the second distribution message; and causing, by the PHD 130, output of the first and second distribution messages from the PHD 130 to at least one client device. As discussed above, selectively routing a market data update message to the PHD or the processor device at which a distribution message is generated therefrom, according to the present disclosure, and outputting, from the PHD, the distribution messages generated at the PHD and the processor device for publishing market data updates to respective client devices, advantageously provides that market data update messages for asset types typically received in high volumes and over very short time periods, such as market data update messages for on-the-run U.S. treasuries, may be received and processed with minimal latency at a computing system of the present disclosure, to enable real time, timely and low latency publication of event data of market data events for such asset types to client devices of respective subscribers permissioned to receive filtered event data of the market data events.

Referring to FIG. 3A, in block 301, a computing device 210 associated with an event circuit 224 may, automatically, or at least partially in response to an input from another computing device or a human, generate event data representative of occurrence of a market data event. A market data event may be, for example, an order state including cancelation of an existing trade order for an asset, matching or execution of a trade order for an asset of a first party with a trade order for an asset of a second party, receipt of a new trade order for an asset, receipt of a change to an existing trade order, such as to price or size, etc. The event data may include asset trade data including, for example, price, quantity, orientation (buy or sell), identifier of an asset, such as an equity, U.S. treasury bond or intangible asset, such as cryptocurrency, identifier of each party involved in a trading related event and a time that the event occurred, such as a time a revision to an order was received or completed, or a time that a trade involving two orders was executed.

In addition, in block 301 the computing device 210 may, based on occurrence of a market data event, automatically control the event circuit 224 to generate, and transmit over a communication path 226 to the interface circuit 150 of the system 100, a market data update message including event data and an event time of the market data event. The event time may be based on a time of a local clock of the event circuit 224 when the event circuit 224 transmits a market data update message, based on an instruction received from the computing device 210. A time of the local clock of an event circuit 224 may be based on, and desirably synchronized with, a time of the system clock of the system 100.

In one embodiment, a computing device 210 or an event circuit 224 associated with a computing device, such as the computing device 210A and associated event circuit 224A, may store, in a memory of the computing device 210 or the event circuit 224, the event time of a specific market data event contained in a market data update message transmitted from an event circuit.

Further in block 301, the interface circuit 150 may receive, over the communication paths 226, respective market data update messages containing event data of market data events from the event circuits 224.

In one embodiment, the interface circuit 150 may allocate a portion of memory of the PHD 130 to store and process each market data update message received by the interface circuit 150.

In block 303, the interface circuit 150 may route to the selection circuit 160, over data paths 230, the market data update messages received respectively over the communication paths 226.

In one embodiment, the interface circuit 150 may determine, for each market data update message received at the interface circuit 150, an event receipt time, which is a current time of the system clock when the market data update message is received at the interface circuit 150. The interface circuit 150 may store in memory, such as in the PHD 130 or the memory 126, for each specific market data event, an event receipt time of the market data update message indicating the specific market data event.

In block 303, the interface circuit 150 may route to the selection circuit 160, over data paths 230, the market data update messages received respectively over the communication paths 226.

Further in block 303, the selection circuit 160 may extract, from each market data update message, data indicating an asset type that is the subject of a market data event indicated in the market data update message. The selection circuit 160 may determine the asset type from the extracted data. In addition, the selection circuit 160 may retrieve, from memory, asset type information indicating asset types associated with FastPath and SlowPath processing. The selection circuit 160 may compare the asset type information with the extracted asset type, and when the asset type is determined to correspond to FastPath processing, route the market data update message over the FastPath 240, and when the asset type is determined to correspond to SlowPath processing, route the market data update message over the SlowPath 250 to external the PHD 130.

When a market data update message is routed over the SlowPath 250, the PHD 130 may immediately provision memory of the PHD 130, which had been used to store and process the market data update message, to store and process another market data update message. The selective routing of market data update message of certain asset types over the SlowPath to the processing device 140, and immediate provisioning, following routing of a market data update message over the SlowPath, the memory in the PHD 130 to store and process another market data update message in a memory portion of the PHD 130 previously allocated to the market data update message, frees memory and also processing resources at the PHD 130 to provide that the PHD 130 may have sufficient memory and processing resources to receive and process, with minimal or no latency or errors, bursts of market update data messages for asset types having high rates of market data event occurrence, such as on-the-run U.S. treasuries. Advantageously, the memory and processing resources of the PHD, such as of an FPGA, which may provide very high speed processing of market data updates message but have memory size limitations, are allocated for storing and processing only market data update messages of asset types that typically have high rates of event occurrence, while those market data update messages of asset types having lower rates of event occurrence are processed by processors of a processing device external to the PHD. As discussed below, the distribution messages generated by the processing device 140 are routed into the PHD 130 to permit distribution therefrom, based on distribution times of market data events of the distribution messages, with low latency and to provide for fairness in publication of market data events to subscribers of the market data event publication service.

In block 305, the feed generation circuit 170 may receive the market data update messages routed over the FastPath 240. In addition, the feed generation circuit 170 may extract data from each market data update message received at the feed generation circuit 170, and based on the extracted data identify a market data event indicated in the market data update message. In addition, in block 305, also by extracting data from a market data update message, the feed generation circuit 170 may, for each market data event identified, determine event data and the event time of the market data event.

In one embodiment, the feed generation circuit 170 may store in the memory 126, for a specific market data event, event data and an event time for the specific market data event which are included in a market data update message indicating the specific market data event.

In one embodiment, a market data update message may contain permission-related information indicating an identity of a subscriber that is or is not permissioned to receive certain event data of a market data event, such as a market data event indicated in the market data update message or a different market data event not indicated in the market data update message. In addition, the permission-related information may indicate a characteristic, type or component of event data of a market data event that a subscriber is or is not permissioned to receive. The feed generation circuit 170 may extract this permission-related information from a market data update message, and store the permission-related information as filter information in the memory 126.

In addition, in block 305, for each market data event in a market data update message received at the feed generation circuit 170, the feed generation circuit 170 may, based on filter information, determine filtered event data from the event data of the market data event and distribution information for the filtered event data. The distribution information for the filtered event data may indicate one or more client devices of one or more subscribers permissioned to receive the filtered event data for a specific market data event. In one embodiment, the distribution information may indicate a specific subscriber(s) that, based on the filter information, is permissioned to receive certain event data of a market data event as filtered event data.

In one embodiment, the memory 126 may include filter information indicating an identity of a subscriber of the system 100 that is or is not permissioned to receive certain event data of a specific market data event, and a characteristic, type or component of the event data that the subscriber can or cannot receive. For example, the filter information may indicate that a subscriber is not permitted to receive certain event data, such as the identities of the parties to an executed trade as the market data event, unless the subscriber is affiliated with a party to the executed trade. The filter information may provide that all or a portion of the event data of the market data event in the market data update message is the filtered event data for a specific subscriber. Accordingly, filtered event data for a same market data event for client devices of respective users may be different and vary in byte size in distribution messages, based on the filter information.

Further in block 305, for each filtered event data determined for a market data event, the feed generation circuit 170 may generate a distribution message. The distribution message may include the filtered event data, and an event time of the market data event. In one embodiment, the event time may be included as metadata of the distribution message.

In one embodiment, the feed generation circuit 170 may generate, based on the filter information, multiple distribution messages for respective client devices 290. For example, the feed generation circuit 170 may generate distinct distribution messages for a market data event for respective client devices, where each distribution message includes a different portion of the event data for a same market data event as the filtered event data. In one embodiment, the feed generation circuit 170 may maintain, in memory of the PHD, order books for respective instruments of interest for a client that is a subscriber to the publication service, and update an order book of the subscriber, based on the filtered event data for a market data event in a distribution message to be transmitted to the client device of the subscriber. The order book, for example, may be arranged with a list of orders, where an order indicated as a market data event in a market data update message is included in the list based on a price of the order and an event time indicated in the market data update message.

In block 308, based on the configuration information and one or more client devices indicated in the distribution information for distribution messages, the feed generation circuit 170 may route the distribution messages for respective different client devices in individual distinct feeds on respective data paths 260.

Referring to FIG. 2, the feed generation circuit 170 may route distribution messages having different filtered event data for a same market data event and respectively which are for different client devices 290A, 290B and 290C, in feeds A, B and C respectively over data paths 260A, 260B and 260C to the distribution circuit 180. In addition, the feed generation circuit 170 may route a single distribution message for a market data event, which is for client devices 290D and 290H, in feed D over data path 260D to the distribution circuit 180. A distribution message in the feed D, for example, may include all event data for a market data event.

Referring to FIG. 3E, in block 400, the processing device 140 may receive market data update messages routed over the SlowPath 250. In one embodiment, the market data event feeder 300 may receive the market data update messages routed over the SlowPath 250, and perform operations and functions substantially similar to operations and functions described above for the feed generation circuit 170, including extracting data from each market data update message received, to determine a market data event and event data and an event time of the market data event.

In one embodiment, the market data event feeder 300 may store in the memory 126, for a specific market data event, event data and an event time for the specific market data event. Also, the market data event feeder 300 may extract any permission-related information from a market data update message, and store the permission-related information as filter information in the memory 126.

Also, in block 400, for each market data event in a market data update message received at the market data event feeder 300, the market data event feeder 300 may, based on filter information, determine distribution information indicating one or more client devices of one or more subscribers permissioned to receive filtered event data for a specific market data event.

In block 402, the market data event feeder 300 may, based on the filter information, provide event data of the market data event to a processor 304 corresponding to a specific subscriber(s) that is permissioned to receive certain event data of the market data event as filtered event data. In one embodiment, the market data update message indicating the market data event may be provided to a processor 304.

In block 404, a processor 304 may execute instructions, which reflect or are based on the filter information, to process event data of a market data event, and generate a distribution message for the market data event for the client device of the specific subscriber, where the distribution message includes filtered event data and an event time of the market data event. In one embodiment, the event time may be included as metadata of the distribution message. Further, the processor 304 may update an order book for an order indicated as the market data event, similarly as described above.

In one embodiment, the filter information specific to a subscriber may be changed during operation of the system 100, to provide that a processor 304 may generate a distribution message containing different event data as filtered event data for a market data event of a specific asset type and involving certain characteristics, where the filtered event data is reflective of the change to the filter information.

In block 406, a processor 304 may route a distribution message for one or more client devices 290 generated at the processor 304 as a feed over a data path 306. For example, respective processors 304 may generate distinct distribution messages for a market data event for respective client devices, where each distribution message includes, as filtered event data, a different portion of the event data for a same market data event. Based on the configuration information, the processors 304 may route the distribution messages for respective client devices in distinct feeds on respective data paths 306.

For example, referring to FIG. 2, the market data event feeder 300 may provide a same market data event to processors 304A and 304C over data paths 302A and 302C which are for different client devices 290F and 290H, and 290G. The processor 304A may generate a single distribution message having filtered event data for the market data event, which is for client devices 290F and 290H, and route the distribution message in feed F over data path 306A to the distribution circuit 180. The processor 304C may generate a distribution message for the client device 290G having filtered event data for the market data event different from the filtered event data generated for the same market data event in the processor 304A, and route the distribution message in feed H over data path 306C to the distribution circuit 180.

In addition, each processor 304 may update an order book for an instrument for a subscriber, which is stored in the memory 126 and maintained for the subscriber by the processing device 140, based on the distribution message that is generated for transmission to the client device of the subscriber and includes the filtered event data that the processor 304 determines for the market data event. In one embodiment, a processor 304 may be configured, based on filter information, to update an order book or generate a distribution message, implementing features not available for implementation in an order book or a distribution message generated in the PHD 130. Based on the ease with which instructions to be executed by the processor 304 may be updated to reflect changes to filter information that corresponds to different features available for implementation in an order book or a distribution message, the publication of event data for the asset types associated with the SlowPath processing may be readily and quickly changed and reconfigured. In contrast, as reprogramming the PHD 130, such as the FPGA of or constituting the PHD 130, requires more time and resources than changing instructions to be executed by a processor 304, the filtered event data of a market data event that is published to a subscriber may be changed more quickly and easily for asset types associated with SlowPath processing than FastPath processing, thereby providing increased flexibility and speed in changing or formatting content that is published to clients for market data events associated with SlowPath processing.

Referring again to FIG. 3A, in block 310, the distribution circuit 180 may receive the feeds including distribution messages routed over the data paths 260 from the feed generation circuit 170 and the data paths 306 from the processors 304 of the processing device 140. In addition, in block 310 the distribution circuit 180 may determine each distinct market data event indicated in the feeds received at the distribution circuit 180.

In block 312, for each distinct market data event determined in block 310, the distribution circuit 180 may determine each distribution message for the market data event to be transmitted to a client device of a permissioned user, based on the distribution messages for the market data event in the feeds received by the distribution circuit 180 and the configuration information of the system 100.

In block 314, distribution circuit 180 may determine a distribution time for each distribution message for the market data event to be transmitted to a client device of a permissioned user as determined in block 312. In one embodiment, a distribution message to be transmitted for a market data event, as determined in block 312, may have a one-to-one correspondence with a distribution message in a feed to the distribution circuit 180. For example, based on a single distribution message for a market data event on feed A on data path 260A, a single distribution message for the market data event may be determined for transmission from the output circuit 190A to a client device 290A. In another embodiment, distribution messages to be transmitted for a market data event, as determined in block 312, may have an N-to-one correspondence with a distribution message in a feed to the distribution circuit 180. For example, based on a single distribution message for a market data event on feed F on data path 306A, two distribution messages, which are replicas of the single distribution message for the market data event on feed F, may be determined for transmission from the output circuits 190F and 190H respectively to the client devices 290F and 290H.

In one embodiment, the distribution time for each distribution message for a specific market data event may be determined as a sum of the event time for the market data event, a hold delay for the distribution message and a network latency offset for the distribution message. In one embodiment, the network latency offset may include a propagation delay offset corresponding to the computing device 290 indicated by the distribution information for the distribution message and a serialization offset for the distribution message. The propagation delay offset for a computing device 290 indicated for a distribution message may be retrieved from the memory 126, and a serialization offset for a distribution message may be determined, similarly as discussed above. In addition, the hold delay for a given distribution message, which may be a same hold delay used to determine a distribution time for all distribution messages to be published, or alternatively a hold delay having a value specific to a feed including the given distribution message, may be retrieved from the memory 126.

In one embodiment, the distribution message may indicate a byte size of the filtered event data.

In one embodiment, the distribution circuit 180 may determine, for each distribution message, a byte size of the filtered event data.

In one embodiment, the distribution circuit 180 may generate a queue in the memory 126 or memory in the PHD 130, which lists, in chronological order based on respective event times, market data events, such as determined in block 312, corresponding to the filtered event data in the distribution messages received by the distribution circuit 180 from the feed generation circuit 170 and the processing device 140. In addition, the distribution circuit 180 may, for each market data event in the queue, list, in chronological order, each distribution message to be transmitted for the market data event as determined in block 312, according to respective distribution times. In one embodiment, where a single distribution message in a feed is replicated multiple times for multiple client devices, such as for a distribution message routed over data path 306A, the distribution circuit 180 may include in the queue a representation of each replicated distribution message to be transmitted, in chronological order based on distribution times respectively of the replicated distribution messages.

In one embodiment, a distribution time for a distribution message may be determined from as follows: Distribution Time=event time for the market data event of the distribution message+hold delay for the distribution message+network latency offset, where the network latency offset is a sum of a propagation delay offset for the client device to which the distribution message is to be transmitted and a serialization offset associated with transmission of the distribution message from the system 100.

The distribution circuit 180 may determine whether a distribution time for a distribution message in the queue is satisfied, by comparing a current time of the system clock with the distribution time of the distribution message. When the current time of the system clock is determined to be the same as or after the distribution time, the distribution time for a distribution message is satisfied.

In block 316, the distribution circuit 180 may route the distribution messages for each market data event determined in block 312, over data paths 270 to respective output circuits 190, according to the configuration information. For example, based on a distribution message for a market data event on feed A on data path 260A, the distribution message for the market data event may be routed over the data path 270A for transmission from the output circuit 190A to a client device 290A. In addition, two distribution messages, which are replicas of a single distribution message routed over data path 306A, may be routed by fanout by the distribution circuit 180 over respective data paths 270F and 270J for transmission by output circuits 190F and 190H, respectively, to client devices 290F and 290H.

In one embodiment, in block 316 a distribution message for a market data event determined in block 312 may be routed to an output circuit 190 at a routing time that is based on whether the distribution message is one of several distribution messages replicated from a distribution message of a feed on a data path 260 or 306 received at the distribution circuit 180, in accordance with the configuration information. For example, the distribution circuit 180 may, without delay, route distribution messages on data paths 260A, 260B and 260C, upon receipt by the distribution circuit 180, over data paths 270A, 270B and 270C to respective output circuits 190A, 190B and 190C. In another example, the distribution circuit 180 may route the two distribution messages, which are replicated from a distribution message on a feed F of data path 306A, simultaneously by fanout on data paths 270F and 270J to respective output circuits 190F and 190H, based on a determination that a predetermined routing time for the two distribution messages is satisfied. The predetermined routing time may be equal to a sum of a hold delay for the feed F, a maximum network latency offset of the network latency offsets associated with transmission of the two distribution messages from the output circuits 190F and 190H, and an event time for the two distribution messages. In block 316, when the distribution circuit 180 determines a current time of the system clock is equal to or after the predetermined routing time for the two distribution messages, the distribution circuit 180 may determine the predetermined routing time is satisfied and route simultaneously, by fanout, the two distribution messages over data paths 270F and 270J respectively to the output circuits 190F and 190H.

In block 318, distribution circuit 180 may cause transmission of distribution messages from the PHD 130, based on whether the system 100 is operating in an event time priority mode or a distribution time priority mode, and a comparison of the distribution times respectively of the distribution messages and the current time of the system clock. In an event time priority mode, all distribution messages for a first market data event in the queue having an earliest event time are transmitted (published) from the system 100, before any distribution message for a second market data event in the queue, which is chronologically the next market data event in the queue following the first market data event, is transmitted from the system 100. In a distribution time priority mode, a distribution message is transmitted based on a determination that the distribution time of the distribution message is satisfied, regardless of an event time of a market data event corresponding to the distribution message. In the distribution time priority mode, a distribution message for a second market data event, which has a second event time after a first event time corresponding to a distribution message for a first market data event, may be transmitted before the distribution message for the first market data event.

When the system 100 is operating in an event time priority mode, in block 320 the distribution circuit 180 may determine a next unpublished market data event in the queue. A next unpublished market data event is a market data event in the queue having an earliest event time and for which none of the distribution messages of the market data event has been transmitted. Stated another way, a next unpublished market data event is a market data event in the queue for which a determination is that a distribution time has not been determined as satisfied for any of the distribution messages for the market data event in the queue.

In block 322, for a subject market data event determined as the next unpublished market data event in block 320, the distribution circuit 180 may determine whether a distribution time is satisfied for a distribution message of the subject market data event. In one embodiment, distribution messages for a subject market data event in the queue are processed chronologically in the order in the queue, to determine whether a distribution time is satisfied. The distribution circuit 180 may determine a distribution time for a distribution message is satisfied when the current time of the system clock is the same as or after the distribution time. When the distribution time for a distribution message is determined not to be satisfied, the distribution circuit 180 may continue periodically, at predetermined intervals, such as every 2 nsec, to compare the distribution time with the current time of the system clock, and determine whether the distribution time is satisfied. In addition, the distribution circuit 180 may remove a distribution message from the queue, when a distribution time of the distribution message is determined to be satisfied.

In block 324, for a distribution message for which the distribution time is determined to be satisfied in block 322, the distribution circuit 180 may cause the distribution message to be transmitted from the output circuit 190 to which the distribution message is routed, over a communication path 280 to the client device 290 communicatively coupled to the output circuit 190. In one embodiment, a distribution message, such as routed over feed D over data path 270D or 270K, may be at an output circuit 190, such as output circuit 190D or 190H, when the distribution time for the distribution message is determined to be satisfied. In this embodiment, the distribution circuit 180 may cause the distribution message, which is at an output circuit 190, to be transmitted from the output circuit 190 when the distribution time for the distribution message is determined to be satisfied in block 322.

In one embodiment, the distribution time for a distribution message may be determined to be satisfied at the same instance that, or after, a predetermined routing time for the distribution message is determined to be satisfied in block 316. For example, the distribution time and the predetermined routing time for a distribution message may be determined to be satisfied at a same time, based on respective comparisons of the distribution time and the predetermined routing time with a same current time of the system clock. In the circumstance when both the distribution time and the predetermined routing time for a distribution message are determined to be satisfied at a same time, the distribution message may be routed, as part of a fanout, from the distribution circuit 180 to an output circuit 190, which transmits the distribution message over a communication path 280 upon receipt without delay. In addition, in the circumstance when the distribution time for a distribution message is determined to be satisfied for an instance of a comparison with a current time of the system clock which is subsequent to a current time of the system clock when an instance of comparison with the current time of the system clock determines the predetermined routing time for the distribution message is satisfied, the distribution message, which is being held at an output circuit 190, may be transmitted from the output circuit 190, over a communication path 280 to a client device 290 communicatively coupled to the output circuit 190.

In one embodiment, in block 324 the output circuit 190 may transmit a distribution message using a predetermined message format indicated in the configuration information for the system 100. The predetermined message format may have a message format different from a message format of a market data update message in which event data of the market data event being published by the distribution message was received by the system 100.

In block 326, the distribution circuit 180 may determine from the queue whether all distribution messages for the subject market data event have been transmitted. If the determination in block 326 is that not all distribution messages for the subject market data event have been transmitted, processing may continue in block 322 to determine whether a distribution time for a distribution message in the queue is satisfied. If the determination in block 326 is all distribution messages for the subject market data event have been transmitted, processing may continue in block 320 to determine a next unpublished market data event in the queue, chronologically following the last market data event for which all the distribution messages have been transmitted.

In one embodiment, the distribution circuit 180 may determine whether, for a specific market data event, several distribution times of respective distribution messages are satisfied, and when the several distribution times are determined to be satisfied, cause transmission of the distribution messages simultaneously from the system 100. The distribution times of several distribution messages for a market data event may be determined to be satisfied for a same instance of a comparison with a current time of the system clock in block 322, for example, when, due to differences in network latency offsets, a distribution time for a distribution message of a next market data event in the queue is earlier or the same as a latest distribution time for a prior market data event in the queue.

It is to be understood that, in the distribution time priority mode, the system 100 may control routing of distribution messages, as determined in block 312, from the distribution circuit 180 to respective output circuits 190, similarly as discussed above for the event time priority mode.

When in block 318 the system 100 is determined to be operating in a distribution time priority mode, referring to FIG. 3D in block 330 the distribution circuit 180 may determine whether a distribution time for any distribution message in the queue is satisfied. If no distribution time is determined to be satisfied in block 330, processing in block 330 is repeated. In block 330, the distribution circuit 180 may continuously determine, at predetermined intervals, a current time of the system clock, and compare the current time of the system clock with distribution times of distribution messages in the queue, to determine whether a distribution time for any distribution message is satisfied.

In one embodiment, in block 330 the distribution circuit 180 may determine an earliest distribution time for a distribution message(s) in the queue, and compare the earliest distribution time with a current time of the system clock to determine whether the earliest distribution time is satisfied.

If a distribution time for a distribution message is determined to be satisfied in block 330, in block 332 the distribution circuit 180 may cause transmission of the distribution message from the specific output circuit 190 to which the distribution message is routed from the distribution circuit 180, to the client device 290 communicatively coupled to the specific output circuit 190. In addition, in block 332, the distribution circuit 180 may remove a distribution message from the queue, when a distribution time of the distribution message is determined to be satisfied in block 330.

In one embodiment, where the distribution times of several distribution messages are determined to be satisfied in block 330, in block 332 the distribution circuit 180 may cause simultaneous transmission of the several distribution messages from the specific output circuits 190 to which the several distribution messages were routed, respectively to the client devices 290 communicatively coupled to the specific output circuits 190.

In one embodiment, where several distribution messages are determined to be satisfied in block 330 and two or more of the several distribution messages are for a same client device 290, the distribution circuit 180 may cause transmission of the two or more distribution messages for the same client from a same output circuit 190 in chronological order of event times corresponding to the two or more distribution messages.

Thus, in the distribution time priority mode, for a same event, the client devices of respective permissioned users may receive the filtered event data at the same or substantially the same time. However, in the distribution time priority mode, some client devices may receive filtered event data of a subsequent market data event before all client devices permissioned to receive event data of a previous market data event receive filtered event data of the previous market data event.

In block 334, the distribution circuit 180 may determine whether any distribution messages remain in the queue. If the queue does not include any distribution messages, processing continues in block 334 until a distribution message is determined to be in the queue. If the determination in block 334 is the queue includes a distribution message, operation continues from block 330.

Referring to FIG. 2, an exemplary operation of the process 350 implemented with the system 100 is described below. In the example, the interface circuit 150 receives, over the communication paths 226A, 226B, 226C and 226D, market data update messages from event circuits 224A, 224B, 224C and 224D respectively indicating Event-1, Event-2, Event-3 and Event-4, where each event describes an electronic asset trading event. The event times of Event-1, Event-2, Event-3 and Event-4 are times of the system clock of the system 100 respectively when the market data update messages indicating Event-1, Event-2, Event-3 and Event-4 are transmitted. Event-1 has an event time T1, Event-2 has an event time T2 where T2=T1+Delta 1 and Delta 1 is a positive value, Event-3 has an event time T3 where T3=T1+Delta 2 and Delta 2>Delta 1 and Event-4 has an event time T4 where T4=T1+Delta 3 and Delta 3>Delta 2. The selection circuit 160 determines, based on asset type information indicated in the market data update messages, that the Event-1 and Event-2 messages are for FastPath processing, and the Event-3 and Event-4 messages are for SlowPath processing. The selection circuit 160 routes the Event-3 and Event-4 messages over the SlowPath 250, external to the PHD 130, and immediately thereafter provisions memory in the PHD 130 used for the Event-3 and Event-4 messages to be available for receiving and processing other market data update messages in the PHD 130. In addition, the selection circuit 160 routes the Event-1 and Event-2 messages over the FastPath 240 to the feed generation circuit 170. The feed generation circuit 170, based on filter information, generates: Distribution Message 1 including filtered event data 1A of Event-1 and metadata indicating an event time T1, and distribution information indicating Distribution Message 1 is for client device 290A; Distribution Message 2 including filtered event data 1B of Event-1 and metadata indicating an event time T1, and distribution information indicating Distribution Message 2 is for client device 290B; Distribution Message 3 including filtered event data 1C of Event-1 and metadata indicating an event time T1, and distribution information indicating Distribution Message 3 is for client device 290C; Distribution Message 4 including filtered event data 2A of Event-2 and metadata indicating an event time T2, and distribution information indicating Distribution Message 4 is for client device 290D and 290H; and Distribution Message 5 including filtered event data 2B of Event-2 and metadata indicating an event time T2, and distribution information indicating Distribution Message 5 is for client device 290E and 290G. Based on the configuration information and distribution information for the respective Distribution Messages 1-5, the Distribution Messages 1, 2 and 3 are routed in feeds A, B and C over data paths 260A, 260B and 260C respectively, the Distribution Message 4 is routed in feed D over data path 260D and the Distribution Message 5 is routed in feed E over data path 260E.

Continuing with the example, the market data event feeder 300, based on the filter information, provides the Event-3 message to the processor 304A and the processor 304C, and the Event-4 message to the processor 304B. Based on the filter information, the processor 304A generates a Distribution Message 6 including filtered event data 3A for the client device 290F and the client device 290H and metadata indicating an event time T3; the processor 304C generates a Distribution Message 7 including filtered event data 3B for the client device 290G and metadata indicating an event time T3; and the processor 304B generates a Distribution Message 8 including filtered event data 4 for the client device 290F and metadata indicating an event time T4. The processors 304A, 304B and 304C route the Distribution Messages 6, 8 and 7 on feeds F, G and H respectively over the data paths 306A, 306B and 306C to the distribution circuit 180.

Also, in the example, the propagation delay offsets for client devices 290A, 290B, 290C, 290D, 290E, 290F, 290G and 290H are −15 nsec, −10 nsec, −30 nsec, −50 nsec, −60 nsec, −70 nsec, −80 nsec and −85 nsec; T1 is a time zero on the system clock (0 nsec); Delta 1 is 25 nsec such that T2 is 25 nsec; Delta 2 is 30 nsec such that T3 is 30 nsec; and Delta 3 is 200 nsec such that T4 is 200 nsec. In addition, the serialization offsets are −30 nsec, −40 nsec and −70 nsec respectively for Distribution Messages 1-3 of Event-1; −30 nsec and −40 nsec for Distribution Messages 4 and 5, respectively, of Event-2; −50 nsec for Distribution Message 6 of Event 3; −40 nsec for Distribution Message 7 of Event-3; and −20 nsec for Distribution Message 8 of Event-4. The distribution circuit 180 generates Distribution Messages 4A and 4B, as replicas of Distribution Message 4, respectively for client devices 290D and 290H; Distribution Messages 5A and 5B, as replicas of Distribution Message 5, respectively for client devices 290E and 290G; and Distribution Messages 6A and 6B, as replicas of Distribution Message 6, respectively for client devices 290F and 290H.

Further continuing with the example, the distribution circuit 180 determines distribution times for the distribution messages of Event-1, Event-2, Event-3 and Event-4, where the hold delay is 40 microseconds for all feeds of distribution messages to be published, as follows: For Event-1, Distribution Time 1 for Distribution Message 1 is equal to 0+40 microseconds-15 nsec-30 nsec, or 39.955 microseconds; Distribution Time 2 for Distribution Message 2 is equal to 0+40 microseconds-10 nsec-40 nsec, or 39.950 microseconds; and Distribution Time 3 for Distribution Message 3 is equal to 0+40 microseconds-30 nsec-70 nsec, or 39.900 microseconds. For Event-2, Distribution Time 4A for Distribution Message 4A is equal to 25 nsec+40 microseconds-50 nsec-30 nsec, or 39.945 microseconds; Distribution Time 4B for Distribution Message 4B is equal to 25 nsec+40 microseconds-85 nsec-30 nsec, or 39.910 microseconds; Distribution Time 5A for Distribution Message 5A is equal to 25 nsec+40 microseconds-60 nsec-40 nsec, or 39.925 microseconds; Distribution Time 5B for Distribution Message 5B is equal to 25 nsec+40 microseconds-80 nsec-40 nsec, or 39.905 microseconds. For Event 3, Distribution Time 6A for Distribution Message 6A is equal to 30 nsec+40 microseconds-70 nsec-50 nsec, or 39.910 microseconds; Distribution Time 6B for Distribution Message 6B is equal to 30 nsec+40 microseconds-85 nsec-50 nsec, or 39.895 microseconds; Distribution Time 7 for Distribution Message 7 is equal to 30 nsec+40 microseconds-80 nsec-40 nsec, or 39.910 microseconds. For Event-4, Distribution Time 8 for Distribution Message 8 is equal to 200 nsec+40 microseconds-70 nsec-20 nsec, or 40.110 microseconds.

The Table below illustrates a representative arrangement of the distribution messages for the respective events Event-1, Event-2, Event-3 and Event-4 of the example in a queue, chronologically by event time and also chronologically by distribution times for respective distribution messages of each event. For convenient reference, the Table further includes other information associated with the respective distribution messages.

TABLE

| | | | | Propagation | Distribu- |
|---|---|---|---|---|---|
| | Distribu- | Filtered | Destination | Delay Offset + | tion Time |
| | tion | Event | Client | Serialization | (micro- |
| Event | Message | Data | Device | Offset (nsec) | seconds) |
| Event-1 | 3 | 1C | 290C | −30 + −70 | 39.900 |
| Event-1 | 2 | 1B | 290B | −10 + −40 | 39.950 |
| Event-1 | 1 | 1A | 290A | −15 + −30 | 39.955 |
| Event-2 | 5B | 2B | 290G | −80 + −40 | 39.905 |
| Event-2 | 4B | 2A | 290H | −85 + −30 | 39.910 |
| Event-2 | 5A | 2B | 290E | −60 + −40 | 39.925 |
| Event-2 | 4A | 2A | 290D | −50 + −30 | 39.945 |
| Event-3 | 6B | 3A | 290H | −85 + −50 | 39.895 |
| Event-3 | 6A | 3A | 290F | −70 + −50 | 39.910 |
| Event-3 | 7 | 3B | 290G | −80 + −40 | 39.910 |
| Event-4 | 8 | 4 | 290F | −70 + −20 | 40.110 |

For the example, with the system 100 operating in the event priority mode, referring to the Table, and assuming a comparison with the current time of the system clock is performed every 2 nsec starting from a current time of the system clock being 1 nsec, Event-1 may be determined as a next unpublished market data event, and after all distribution messages, namely, Distribution Messages 3, 2 and 1, for Event-1 are transmitted in sequence, Event 2 may be determined as the next unpublished market data event. In addition, all distribution messages for Event-1, namely Distribution Messages 3, 2 and 1 are transmitted (based on determinations that Distribution Times 3, 2 and 1 are satisfied) despite that Distribution Times 5B, 4B, 5A and 4A respectively for the Distribution Message 5B, 4B, 5A and 4A of Event-2 are chronologically earlier than the Distribution Time 1 of Distribution Message 1. The Distribution Messages 5B, 4B, 5A and 4A are not transmitted when the current time of the system clock is 39.955 microseconds or earlier, because the system 100 does not transmit any distribution messages of Event-2, until the Distribution Messages 3, 2 and 1 of Event-1, which have distribution times 39.555 microseconds or earlier, are transmitted. When the system clock indicates, for example, 39.957 microseconds, in block 316 the distribution circuit 180, when comparing the current time of the system clock with the earliest distribution times in the queue, determines that Distribution Times 5B, 4B, 5A and 4A respectively for the Distribution Message 5B, 4B, 5A and 4A of Event-2 are satisfied, and causes simultaneous transmission of the Distribution Message 5B, 4B, 5A and 4A from the output circuits 190G, 190H, 190E and 190D to the client devices 290G, 290H, 290E and 290D, respectively. Further referring to the Table, when the current time of the system clock is 39.959 microseconds, the output circuits 190F, 190H and 190G are caused to simultaneously transmit the Distribution Messages 6A, 6B and 7, which is after the Distribution Messages 5B, 4B, 5A and 4A of Event-2 are transmitted based on the current time of the system clock being 39.959 microseconds. When the current time of the system clock is 40.111 microseconds, the Distribution Message 8 is transmitted from the output circuit 190F.

Referring again to the Table, with the system 100 operating in the distribution time priority mode, and again assuming a comparison with the current time of the system clock is performed every 2 nsec starting from a current time of the system clock being 1 nsec, when the current time of the system clock is 39.911 microseconds, such that Distribution Messages 3 and 5B of Event-1 and Event-2 respectively have been transmitted, Distribution Message 4B of Event-2, Distribution Message 6A of Event-3 and Distribution Message 7 of Event-3 are transmitted from output circuits 190H, 190F and 190G, respectively to the client devices 290H, 290F and 290G and 270C, respectively.

Advantageously, the technical problem of processing market data update messages for market data events received by a market data publication computing platform, which include market data update messages typically received in high volumes over very short time periods, with low latency, and timely publishing event data of the market data events to subscribers permissioned to receive at least some portion of the event data, is solved by the technical solution of the present disclosure that selectively routes market data update messages, based on asset type, to circuitry of a programmable hardware device, or a processor that executes software instructions, which generates distribution messages of event data of market data events indicated in the market data update messages, and where the circuitry facilitates timely transmission of the distribution messages to client devices, desirably with equalization of network latencies associated with transmission of the distribution messages to the client devices.

Additionally, the present technology may be configured as below.
(1) An apparatus including at least one programmable integrated circuit configured to be communicatively coupled to a plurality of computing devices as market data update sources;
in which the at least one programmable integrated circuit includes:
an interface circuit configured to receive, from each computing device, a market data update message;
a selection circuit configured to selectively route a market data update message received at the interface circuit over a first path or a second path, based on an asset type indicated in the market data update message, in which the second path extends external to the at least one programmable integrated circuit;
a feed generation circuit configured to generate, for a first market data update message received over the first path from the selection circuit, based on filter information, at least one first distribution message; and
a distribution circuit configured to:
   receive, from the feed generation circuit, the at least one first distribution message for the first market data update message and, from external to the at least one programmable integrated circuit, at least one second distribution message for a second market data update message routed from the selection circuit over the second path; and
   cause the at least one programmable integrated circuit to output the at least one first distribution message and the at least one second distribution message respectively to at least one first client device of a plurality of client devices.
(2) The apparatus according to (1), in which the at least one programmable integrated circuit includes a field programmable gate array (FPGA) including the interface circuit, the selection circuit, the feed generation circuit and the distribution circuit.

The apparatus according to (1) or (2), further comprising:
a processor device external to the at least one programmable integrated circuit and including a plurality of processors, in which the processor device is configured to:
receive the second market data update message routed over the second path;
generate, based on the filter information, a plurality of second distribution messages for the second market data update message respectively at the plurality of processors; and
route the plurality of second distribution messages to the distribution circuit.
(4) The apparatus according to any one of (1) to (3), in which the processor device is configured to:
provide the second market data update message to first processors of the processors, based on the filter information;
at each of the first processors, generate a given second distribution message based on the filter information; and
route each given second distribution message from the each of the first processors to the distribution circuit.
(5) The apparatus according to any one of (1) to (4), in which the at least one programmable integrated circuit includes at least one output circuit from which at least one of the at least one first distribution message or the at least one second distribution message is output to the at least one first client device.
(6) The apparatus according to any one of (1) to (5), in which the distribution circuit is configured to:
for each given distribution message of the at least one first and the at least one second distribution messages,
determine a given distribution time, in which the given distribution time is determined based on an event time of a market data event indicated in the given distribution message, a network latency offset associated with transmission of the given distribution message to a given client device of the plurality of client devices and a hold delay for the given client device; and
when the given distribution time is determined to be satisfied, cause a given output circuit of a plurality of output circuits of the at least one programmable integrated circuit to transmit the given distribution message to the given client device.
(7) The apparatus according to any one of (1) to (6), in which the computing devices include at least one of a matching engine or a trading exchange.
(8) The apparatus according to any one of (1) to (7), in which each market data update message includes an identifier of the asset type, details of an order for the asset type and an event time.
(9) The apparatus according to any one of (1) to (8), in which the first market data update message includes a first identifier of a first asset type, and the second market data update message includes a second identifier of a second asset type, and
in which the at least one programmable integrated circuit is configured to store:
a first order book for the first asset type in a memory of the at least one programmable integrated circuit, and
a first order indicated in the first market data update message in the first order book based on a first price and a first event time of the first order indicated in the first market data update message.
(10) The apparatus according to any one of (1) to (9), further comprising:
a processor device external to the at least one programmable integrated circuit and including a plurality of processors, in which the processor device is configured to receive the second market data update message routed over the second path; and
in which each processor is configured to store:
   a second order book for the second asset type in a second memory of the apparatus external to the at least one programmable integrated circuit, and
   a second order indicated in the second market data update message in the second order book based on a second price and a second event time of the second order indicated in the second market data update message.
(11) The apparatus according to any one of (1) to (10), further comprising:
a memory configured to store path selection information indicating the first path is associated with a first asset type and the second path is associated with a second asset type,
in which the selection circuit is configured to compare a given asset type indicated in a given market data update message and the path selection information, and route the given market data update message over the first path or the second path when the given asset type indicated in the given market data update message corresponds respectively with the first asset type or the second asset type.
(12) The apparatus according to any one of (1) to (11), in which the at least one programmable integrated circuit is configured to:
store each market data update message, upon receipt at the interface circuit, in a memory of the at least one programmable integrated circuit; and
when a given market data update message is routed over the second path from the selection circuit, provision a portion of the memory in which the given market data update message was stored to store another given market data update message upon receipt at the interface circuit.
(13) A method including controlling, by at least one programmable integrated circuit configured to be communicatively coupled to a plurality of computing devices as market data update sources, in which the at least one programmable integrated circuit includes an interface circuit, a selection circuit, a feed generation circuit and a distribution circuit, to:
receive, at the interface circuit, from each computing device, a market data update message;
selectively route, at the selection circuit, a market data update message received at the interface circuit over a first path or a second path, based on an asset type indicated in the market data update message, in which the second path extends external to the at least one programmable integrated circuit;
generate, at the feed generation circuit, for a first market data update message received over the first path from the selection circuit, based on filter information, at least one first distribution message; and
receive at the distribution circuit, from the feed generation circuit, the at least one first distribution message for the first market data update message and, from external to the at least one programmable integrated circuit, at least one second distribution message for a second market data update message routed from the selection circuit over the second path; and
cause, at the distribution circuit, the at least one programmable integrated circuit to output the at least one first distribution message and the at least one second distribution message respectively to at least one first client device of a plurality of client devices.
(14) The method according to (13), in which the at least one programmable integrated circuit includes a field programmable gate array (FPGA) including the interface circuit, the selection circuit, the feed generation circuit and the distribution circuit.
(15) The method according to (13) to (14), in which the at least one programmable integrated circuit is of an apparatus, in which the apparatus comprises a processor device external to the at least one programmable integrated circuit and including a plurality of processors, and in which the method includes controlling, by the processor device, to:
receive the second market data update message routed over the second path;
generate, based on the filter information, a plurality of second distribution messages for the second market data update message respectively at the plurality of processors; and
route the plurality of second distribution messages to the distribution circuit.
(16) The method according to any one of (13) to (15), further comprising controlling, by the processor device, to:
provide the second market data update message to first processors of the processors, based on the filter information;
at each of the first processors, generate a given second distribution message based on the filter information; and
route each given second distribution message from the each of the first processors to the distribution circuit.
(17) The method according to any one of (13) to (16), further comprising controlling, by the at least one programmable integrated circuit, to, at the distribution circuit:
for each given distribution message of the at least one first and the at least one second distribution messages,
determine a given distribution time, in which the given distribution time is determined based on an event time of a market data event indicated in the given distribution message, a network latency offset associated with transmission of the given distribution message to a given client device of the plurality of client devices and a hold delay for the given client device; and
when the given distribution time is determined to be satisfied, cause a given output circuit of a plurality of output circuits of the at least one programmable integrated circuit to transmit the given distribution message to the given client device.
(18) The method according to any one of (13) to (17), in which each market data update message includes an identifier of the asset type, details of an order for the asset type and an event time.
(19) The method according to any one of (13) to (18), further comprising:
controlling, by the at least one programmable integrated circuit, to:
store each market data update message, upon receipt at the interface circuit, in a memory of the at least one programmable integrated circuit; and
when a given market data update message is routed over the second path from the selection circuit, provision a portion of the memory in which the given market data update message was stored to store another given market data update message upon receipt at the interface circuit.
(20) A non-transitory storage medium configured to store instructions which, when executed by at least one programmable integrated circuit configured to be communicatively coupled to a plurality of computing devices as market data update sources, in which the at least one programmable integrated circuit includes an interface circuit, a selection circuit, a feed generation circuit and a distribution circuit, control to:
receive, at the interface circuit, from each computing device, a market data update message;
   selectively route, at the selection circuit, a market data update message received at the interface circuit over a first path or a second path, based on an asset type indicated in the market data update message, in which the second path extends external to the at least one programmable integrated circuit;
generate, at the feed generation circuit, for a first market data update message received over the first path from the selection circuit, based on filter information, at least one first distribution message; and
receive at the distribution circuit, from the feed generation circuit, the at least one first distribution message for the first market data update message and, from external to the at least one programmable integrated circuit, at least one second distribution message for a second market data update message routed from the selection circuit over the second path; and
cause, at the distribution circuit, the at least one programmable integrated circuit to output the at least one first distribution message and the at least one second distribution message respectively to at least one first client device of a plurality of client devices.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. An apparatus comprising:
at least one programmable integrated circuit configured to be communicatively coupled to a plurality of computing devices as market data update sources;
in which the at least one programmable integrated circuit includes:
an interface circuit configured to receive, from each computing device, a market data update message;
a selection circuit configured to selectively route a market data update message received at the interface circuit over a first path or a second path, based on an asset type indicated in the market data update message, in which the second path extends external to the at least one programmable integrated circuit;
a feed generation circuit configured to generate, for a first market data update message received over the first path from the selection circuit, based on filter information, at least one first distribution message; and
a distribution circuit configured to:
receive, from the feed generation circuit, the at least one first distribution message for the first market data update message and, from external to the at least one programmable integrated circuit, at least one second distribution message for a second market data update message routed from the selection circuit over the second path; and
cause the at least one programmable integrated circuit to output the at least one first distribution message and the at least one second distribution message respectively to at least one first client device of a plurality of client devices.

2. The apparatus of claim 1, in which the at least one programmable integrated circuit includes a field programmable gate array (FPGA) including the interface circuit, the selection circuit, the feed generation circuit and the distribution circuit.

3. The apparatus of claim 2, further comprising:
a processor device external to the at least one programmable integrated circuit and including a plurality of processors, in which the processor device is configured to:
receive the second market data update message routed over the second path;
generate, based on the filter information, a plurality of second distribution messages for the second market data update message respectively at the plurality of processors; and
route the plurality of second distribution messages to the distribution circuit.

4. The apparatus of claim 3, in which the processor device is configured to:
provide the second market data update message to first processors of the processors, based on the filter information;
at each of the first processors, generate a given second distribution message based on the filter information; and
route each given second distribution message from the each of the first processors to the distribution circuit.

5. The apparatus of claim 1, in which the at least one programmable integrated circuit includes
at least one output circuit from which at least one of the at least one first distribution message or the at least one second distribution message is output to the at least one first client device.

6. The apparatus of claim 1, in which the distribution circuit is configured to:
for each given distribution message of the at least one first and the at least one second distribution messages,
determine a given distribution time, in which the given distribution time is determined based on an event time of a market data event indicated in the given distribution message, a network latency offset associated with transmission of the given distribution message to a given client device of the plurality of client devices and a hold delay for the given client device; and
when the given distribution time is determined to be satisfied, cause a given output circuit of a plurality of output circuits of the at least one programmable integrated circuit to transmit the given distribution message to the given client device.

7. The apparatus of claim 1, in which the computing devices include at least one of a matching engine or a trading exchange.

8. The apparatus of claim 1, in which each market data update message includes an identifier of the asset type, details of an order for the asset type and an event time.

9. The apparatus of claim 1, in which the first market data update message includes a first identifier of a first asset type, and the second market data update message includes a second identifier of a second asset type, and
in which the at least one programmable integrated circuit is configured to store:
a first order book for the first asset type in a memory of the at least one programmable integrated circuit, and
a first order indicated in the first market data update message in the first order book based on a first price and a first event time of the first order indicated in the first market data update message.

10. The apparatus of claim 9, further comprising:
a processor device external to the at least one programmable integrated circuit and including a plurality of processors, in which the processor device is configured to receive the second market data update message routed over the second path; and
in which each processor is configured to store:
a second order book for the second asset type in a second memory of the apparatus external to the at least one programmable integrated circuit, and
a second order indicated in the second market data update message in the second order book based on a second price and a second event time of the second order indicated in the second market data update message.

11. The apparatus of claim 1, further comprising:
a memory configured to store path selection information indicating the first path is associated with a first asset type and the second path is associated with a second asset type,
in which the selection circuit is configured to compare a given asset type indicated in a given market data update message and the path selection information, and route the given market data update message over the first path or the second path when the given asset type indicated in the given market data update message corresponds respectively with the first asset type or the second asset type.

12. The apparatus of claim 1, in which the at least one programmable integrated circuit is configured to:
store each market data update message, upon receipt at the interface circuit, in a memory of the at least one programmable integrated circuit; and
when a given market data update message is routed over the second path from the selection circuit, provision a portion of the memory in which the given market data update message was stored to store another given market data update message upon receipt at the interface circuit.

13. A method comprising:
controlling, by at least one programmable integrated circuit configured to be communicatively coupled to a plurality of computing devices as market data update sources, in which the at least one programmable integrated circuit includes an interface circuit, a selection circuit, a feed generation circuit and a distribution circuit, to:
receive, at the interface circuit, from each computing device, a market data update message;
selectively route, at the selection circuit, a market data update message received at the interface circuit over a first path or a second path, based on an asset type indicated in the market data update message, in which the second path extends external to the at least one programmable integrated circuit;
generate, at the feed generation circuit, for a first market data update message received over the first path from the selection circuit, based on filter information, at least one first distribution message; and
receive at the distribution circuit, from the feed generation circuit, the at least one first distribution message for the first market data update message and, from external to the at least one programmable integrated circuit, at least one second distribution message for a second market data update message routed from the selection circuit over the second path; and
cause, at the distribution circuit, the at least one programmable integrated circuit to output the at least one first distribution message and the at least one second distribution message respectively to at least one first client device of a plurality of client devices.

14. The method of claim 13, in which the at least one programmable integrated circuit includes a field programmable gate array (FPGA) including the interface circuit, the selection circuit, the feed generation circuit and the distribution circuit.

15. The method of claim 14, in which the at least one programmable integrated circuit is of an apparatus, in which the apparatus comprises a processor device external to the at least one programmable integrated circuit and including a plurality of processors, and in which the method includes controlling, by the processor device, to:
receive the second market data update message routed over the second path;
generate, based on the filter information, a plurality of second distribution messages for the second market data update message respectively at the plurality of processors; and
route the plurality of second distribution messages to the distribution circuit.

16. The method of claim 15, further comprising controlling, by the processor device, to:
provide the second market data update message to first processors of the processors, based on the filter information;
at each of the first processors, generate a given second distribution message based on the filter information; and
route each given second distribution message from the each of the first processors to the distribution circuit.

17. The method of claim 13, further comprising controlling, by the at least one programmable integrated circuit, to, at the distribution circuit:
for each given distribution message of the at least one first and the at least one second distribution messages,
determine a given distribution time, in which the given distribution time is determined based on an event time of a market data event indicated in the given distribution message, a network latency offset associated with transmission of the given distribution message to a given client device of the plurality of client devices and a hold delay for the given client device; and
when the given distribution time is determined to be satisfied, cause a given output circuit of a plurality of output circuits of the at least one programmable integrated circuit to transmit the given distribution message to the given client device.

18. The method of claim 13, in which each market data update message includes an identifier of the asset type, details of an order for the asset type and an event time.

19. The method of claim 13, further comprising:
controlling, by the at least one programmable integrated circuit, to:
store each market data update message, upon receipt at the interface circuit, in a memory of the at least one programmable integrated circuit; and
when a given market data update message is routed over the second path from the selection circuit, provision a portion of the memory in which the given market data update message was stored to store another given market data update message upon receipt at the interface circuit.

20. A non-transitory storage medium configured to store instructions which, when executed by at least one programmable integrated circuit configured to be communicatively coupled to a plurality of computing devices as market data update sources, in which the at least one programmable integrated circuit includes an interface circuit, a selection circuit, a feed generation circuit and a distribution circuit, control to:
receive, at the interface circuit, from each computing device, a market data update message;
selectively route, at the selection circuit, a market data update message received at the interface circuit over a first path or a second path, based on an asset type indicated in the market data update message, in which the second path extends external to the at least one programmable integrated circuit;
generate, at the feed generation circuit, for a first market data update message received over the first path from the selection circuit, based on filter information, at least one first distribution message; and
receive at the distribution circuit, from the feed generation circuit, the at least one first distribution message for the first market data update message and, from external to the at least one programmable integrated circuit, at least one second distribution message for a second market data update message routed from the selection circuit over the second path; and
cause, at the distribution circuit, the at least one programmable integrated circuit to output the at least one first distribution message and the at least one second distribution message respectively to at least one first client device of a plurality of client devices.
